(19) United States
(12) Patent Application Publication
(10) Pub. No.: US 2025/0161138 A1
(43) Pub. Date: May 22, 2025

(54) FOLDABLE PLATFORM

(71) Applicant: Moving Life Ltd, Netzer Sereni (IL)

(72) Inventors: Yizhaq GOLDMAN, Holon (IL); Zvi Chen LANCMAN, Kiryat Ekron (IL)

(21) Appl. No.: 19/024,054

(22) Filed: Jan. 16, 2025

Related U.S. Application Data
(63) Continuation-in-part of application No. PCT/IL2023/050750, filed on Jul. 18, 2023.

(30) Foreign Application Priority Data
Jul. 18, 2022 (IL) 294851

(51) Int. Cl. A61H 3/04

(52) U.S. Cl. CPC A61H 3/04; A61H 2003/046; A61H 2201/0161; A61H 2201/1633; A61H 2201/1635

(57) ABSTRACT

A device for use to support a user on a surface, which comprises, at least in operation at least one front leg, a right rear leg and a left rear leg, a right arm engaging the left rear leg, thereby constituting a first arm-leg assembly, a left arm engaging the right rear leg, thereby constituting a second arm-leg assembly. The device further comprises a hub to which the first and second arm-leg assemblies are pivotably connected so as to enable the front and rear legs with the corresponding arms to pivot between distal and proximal positions thereof, to bring the device from a deployed state in which the arms and the rear legs are in their distal positions, into a folded state in which the arms and the rear legs are in their proximal position. The arm-leg assemblies form an X-shaped structure when the device is in the deployed state and extend parallel to each other at least along a majority of the length thereof when the device is in the folded state. The arms have a curved shape identical to that of the legs, at least along a majority of the length of the arms, so as to allow the arms to be slidingly aligned with, or be received in, the rear legs at least along the majority of the length of the arms at least when bringing the device into the folded state.

### TECHNOLOGICAL FIELD

The present presently disclosed subject matter is in the field of movement platforms, in particular for or constituted by rollators/walkers, tricycles, strollers, high chairs, and the like.

### BACKGROUND

To aid people with physical limitations, there are several styles of rollable chairs and wheelchairs, including those that can be transformed to rollators (walkers).

U.S. Pat. No. 10,085,909 discloses a collapsible upright wheeled walker with adjustable armrests that support sufficient user upper-body weight to facilitate a natural upright gait and provide unassisted mobility for a wide range of mobility-impaired individuals. The walker may be easily and quickly folded (and unfolded) and may include bilateral stabilizing wheel suspensions to facilitate navigation over uneven terrain. The walker includes a frame-stiffening folder assembly and may also include mechanical brakes, an adjustable upper armrest assembly with removable padded forearm supports and two pairs of handles, at least one of which is disposed sufficiently forward to place the user within the polygonal footprint defined by the front and rear wheels to provide support without requiring leaning, stooping, or risking falls.

U.S. Pat. No. 8,708,363 discloses a folding walker including a first frame of two parallel main supports separated by a horizontal cross bar. An inverted U-shaped second frame has one leg pivotally affixed to each main support of the first frame and pivotal between an extended operable position and a folded storage position. At least one brace extends from an intermediate portion of a leg of the second frame and is pivotally affixed thereto, and an upper end of the brace is slidably attached to an upper portion of one of the main supports of the first frame. At least one tension brace extends between a lower portion of one of the main supports of the first frame and one of the legs of the inverted U-shaped second frame. The tension brace is intermediately hinged wherein a first segment of the tension brace is pivotal with respect to a second segment of the tension brace.

### GENERAL DESCRIPTION

The presently disclosed subject matter relates to a platform for devices or equipment such as rollators/walkers, tricycles, strollers, and the like.

In some examples, the presently disclosed subject matter relates to a rollator or walker (walking aid) configured to be folded and be deployed, as well as be particularly compact when in the folded state, conveniently and quickly.

In accordance with one aspect of the presently disclosed subject matter, there can be provided a platform device for use to support a user on a surface, the device can comprise, at least in operation:
at least one front leg, a right rear leg and a left rear leg, each leg having a proximal end; and a distal end in which the distal end of each leg may directly contact said surface;
a right arm having a distal end and a proximal end, the right arm engaging the left rear leg, thereby constituting a first arm-leg assembly;
a left arm having a distal end and a proximal end, the left arm engaging the right rear leg, thereby constituting a second arm-leg assembly; and
a hub to which the first and second arm-leg assemblies are pivotably connected so as to enable the front and rear legs with the corresponding arms to pivot between distal positions thereof and proximal positions thereof, the distal ends of the legs being closer to each other in the proximal position than in the distal position of the legs, and the proximal position of the legs being achieved by moving the right and left arms from an arms distal position in which the arms are spread apart, to an arms proximal position in which the distal ends of the arms are closer to each other than in the arms distal position, whereby the device can be brought from a deployed state in which the arms and the rear legs are in their distal positions, into a folded state in which the arms and the rear legs are in their proximal position.

The above platform thus can has scissor-like arm-leg structures allowing easy deployment and folding of the platform, in particular, to a particularly compact size, without compromising stability of the platform.

In accordance with another aspect of the presently disclosed subject matter, there can be provided an actuation transmission mechanism, for use with an extendable arm-leg assembly of the kind comprised in the above platform, the assembly can comprise an arm having an actuating element at an arm proximal portion and a leg having an actuatable element at a leg distal end configured to perform an actuated motion when induced at least indirectly by a corresponding actuation motion of the actuating element. In this case, the arm and the leg can be configured to interact in a telescopic movement manner along a longitudinal axis of the assembly, between a retracted state of the arm-leg assembly, in which a distance between the actuating and actuatable elements is of a first length, and an extended state of the arm-leg assembly, in which said distance is of a second length greater than the first length, the actuation transmission mechanism can comprise at least in operation of the assembly:
at least one interconnecting structure comprising
   an arm-associated portion fixedly connected to the actuating element so as to be movable therewith during both the actuation motion and the telescopic movement, and a leg-associated portion fixedly connected to the actuatable element so as to be movable therewith during both the actuated motion and the telescopic movement, the two portions overlapping at an overlapping area having a length along said axis, which changes correspondingly to the change in said distance, and
   an interconnecting element interacting with both the arm-associated portion and the leg-associated portion at said overlapping area so as to induce the actuated motion of the actuatable element upon the actuation motion of the actuation element.

In accordance with a further, alternative aspect of the presently disclosed subject matter, the actuation transmission mechanism can be in the form of a brake mechanism for use in an extendable arm-leg assembly in which the arm and the leg are operably and movably engaged with each other in a telescopic movement manner at least along an overlapping area of the arm-leg assembly, at least one of the arm and the leg having a hollow portion associated with the overlapping area. In this case, the mechanism can comprise:
an actuating element constituted by a brake actuating lever connected to the arm;
an actuatable element constituted by a brake-pad assembly connected to the leg; and
an interconnecting structure constituted by a brake cable unit comprising an outer flexible sleeve and an inner flexible brake cable passing through said sleeve and having an arm-associated portion including one cable end attached to the brake actuating lever and a leg-associated portion including a second cable end attached to the brake-pad assembly, the outer sleeve with the inner cable therewithin that interconnects the arm-associated portion and the leg-associated portion constitutes an interconnecting element forming a loop having such dimensions as to be capable of being received within said hollow portion, wherein the length of the interconnecting element is about equal to the length of at least the overlapping area, wherein the length of the interconnecting element is variable in accordance with that of the overlapping area.

In accordance with a still further aspect of the presently disclosed subject matter, there can be provided a front leg deployment and folding mechanism which can be used with a platform of any of the above aspects, provided it comprises, at least in use, a hub, at least one front leg and a pair of rear legs, the front and rear legs having respective proximal ends being associated with the hub, and distal ends spaced from the hub towards said surface when the device is positioned thereon, the rear legs being moveable between rear legs distal position and rear legs proximal position. In this case, the mechanism can be configured to be at least partially mounted within said hub so as to manipulably interconnect the proximal ends of the at least one front leg and of the rear legs to selectively induce movement of the at least one front leg in response to the movement of the rear legs to move the at least one front leg towards a front leg distal position when the rear legs are moved towards their distal position and towards a front leg proximal position when the rear legs are moved towards in their proximal position.

In accordance with yet another aspect of the presently disclosed subject matter, there can be provided a deployable hung seat assembly which can be used with a platform of any of the above aspects, the seat assembly can comprise:
a seat having a front seat edge and a rear seat edge, attachable to the device pivotable about a seat pivot axis between a seat deployed, raised orientation and seat storage, lowered orientation in which the front seat edge is disposed closer to the right and left rear legs than in the raised orientation and lower than the rear seat edge in a front view; and
a seat lowering-raising mechanism comprising a foldable support element having an upper portion hingebly connected at least indirectly to the seat in the vicinity of the front seat edge about an upper pivot axis, and a lower portion hingedly joined to the upper portion about a folding hinge axis, and hingebly connected at least indirectly to the right and left legs at a location lower than the upper pivot axis in the front view of the assembly, the foldable support element is manipulable between a supporting state, in which the upper portion and lower portion are prevented from hinging with respect to each other, are aligned along a single plane, and are oriented so as to support the seat in the deployed, raised orientation, and a foldable state, in which the upper portion and lower portion are allowed to hinge with respect to each other and the seat is allowed to pivot into its storage, lowered orientation. The seat assembly can further comprise a locking arrangement operable between a locking state in which the upper portion and lower portion are prevented from hinging with respect to each other and a releasing state in which the upper portion and lower portion are allowed to hinge with respect to each other and the seat is allowed to pivot into its storage, lowered orientation.

In accordance with one more aspect of the presently disclosed subject matter, there can be provided a rollable platform, provided it comprises a hub having a reference plane normal to the surface, two first legs, located on different sides of the reference plane and at least one second leg, the first and second legs each having respective proximal ends disposed within the hub and distal ends having wheels operably connected thereto and spaced from the hub towards said surface when the device is positioned thereon, at least one of the first legs is moveable between a retracted position, in which it is spaced from the reference plane to a first distance and a deployed position, in which it is spaced from the reference plane to a second distance larger than the first distance. In this case, each of the first legs can be provided with an orientation maintaining structure comprising an elongated wheel connector configured to be maintained parallel to the reference plane in both the distal and proximal positions of the corresponding first leg.

The above and other aspects of the presently disclosed subject matter can be implemented in the following embodiments:
1. A device for use to support a user on a surface, the device comprising, at least in operation:
at least one front leg, a right rear leg and a left rear leg, each leg having a proximal end; and a distal end in which the distal end of each leg may directly contact said surface;
a right arm having a distal end and a proximal end, the right arm engaging the left rear leg, thereby constituting a first arm-leg assembly;
a left arm having a distal end and a proximal end, the left arm engaging the right rear leg, thereby constituting a second arm-leg assembly; and
a hub to which the first and second arm-leg assemblies are pivotably connected so as to enable the front and rear legs with the corresponding arms to pivot between distal positions thereof and proximal positions thereof, the distal ends of the legs being closer to each other in the proximal position than in the distal position of the legs, and the proximal position of the legs being achieved by moving the right and left arms from an arms distal position in which the arms are spread apart, to an arms proximal position in which the distal ends of the arms are closer to each other than in the arms distal position, whereby the device can be brought from a deployed state in which the arms and the rear legs are in their distal positions, into a folded state in which the arms and the rear legs are in their proximal position.
2. The device of embodiment 1, wherein the right arm is slidingly moveable with respect to the left rear leg and the left arm is slidingly moveable with respect to the right leg, each arm slidable between an extended state in the deployed state of the device; and in which the distal ends of the arms are spaced from the hub, and a retracted state which the arms have in the folded state of the device and in which the distal ends of the arm are disposed adjacent to the hub.
3. The device of embodiment 2, wherein in the retracted state of the arms, the proximal ends thereof are disposed farther from the hub than the distal ends of the arms and closer to the distal ends of the rear legs than the hub.
4. The device of embodiment 1, 2 or 3, wherein the hub has front and rear hub portions and accommodates therewithin proximal ends of at least the two rear legs, which are connected to the hub so as to be pivotable about corresponding longitudinal pivot axes thereof passing through the front and rear portions of the hub at two horizontally spaced apart locations.
5. The device of any one of embodiments 1 to 4, further comprising a front leg deployment and folding mechanism, accommodated within the hub, and operable to move the at least one front leg between a front leg distal position in which the distal end thereof is disposed at a maximal distance from the distal ends of the rear legs when the rear legs are in their distal position, and a front leg proximal position, in which the distal end of the at least one front leg is disposed proximal to the distal ends of the rear legs, when the rear legs are in their proximal position. The front leg deployment mechanism can also comprise a front leg deployment delay mechanism configured to delay movement of the front legs to provide for initial spreading of the rear legs whereby there is space for the front legs to move between the rear legs.
the front leg deployment delay member can be disposed in the hub and be operably attached to front leg gears so that rotation of the front leg gears rotates the delay member in the same direction as the front leg gears.
6. The device of embodiment 5, wherein in the proximal position of the front and rear legs, the at least one front leg is at least partially located between the rear legs.
7. The device of embodiment 5 or 6, wherein the front leg deployment and folding mechanism is operable to move the at least one front leg between the front leg distal and proximal positions, when the rear legs are brought between their respective distal and proximal positions.
8. The device of embodiment 7, wherein the front leg deployment mechanism comprises at least one rear leg transmission gear fixed to the proximal portion of at least one of the rear legs; and at least one front leg transmission gear operably fixed to the proximal portion of the at least one front leg, the at least one front leg transmission gear being disposed so as to mesh with the at least one rear leg transmission gear, whereby movement of the rear legs toward their proximal position rotates the at least one rear leg transmission gear causing the at least one front leg transmission gear to rotate the at least one front leg rearward.
9. The device of any one of embodiments 5 to 8, wherein the front leg deployment mechanism comprises a center-pass spring configured to secure the at least one front leg in place, whether in the folded or deployed state.
10. The device of any one of embodiments 1 to 9, wherein each of the two arm-leg assemblies has a center-line longitudinal axis, wherein the arm-leg assemblies are pivotable so as to form an X-shaped structure when the device is in the deployed state, and to extend parallel to each other at least along a majority of the length thereof when the device is in the folded state.
11. The device of embodiment 10, wherein the center of the X-shaped structure that is formed when the device is in the deployed state thereof is positioned above the pivoting point of each of the assemblies in a side view.
12. The device of embodiment 10 or 11, wherein each center-line longitudinal axis of the arm-leg assemblies has a curved shape, which is identical at least along a proximal portion of the rear legs comprising their proximal ends and a proximal portion of the arms comprising their proximal ends so as to allow at least the proximal portion of the curved arms to be slidingly aligned with, or be received in, at least the proximal portion of the rear legs.
13. The device of embodiment 2 or any one of embodiments 3 to 12 when dependent on embodiment 2 directly or indirectly, wherein the right and left arms are coaxially slidable within their respective left and right rear legs.
14. The device of any one of embodiments 1 to 13, wherein the front and rear legs are oriented parallel to each other when in their proximal position.
15. The device of any one of embodiments 1 to 14, further comprising an arm height-fixing mechanism operable to reversibly lock the arms, in at least two different heights, in the extended state of the arms.
16. The device of embodiment 15, wherein the arm height-fixing mechanism comprises a plurality of pin-receiving apertures formed in at least one of the arms and at least one height-locking pin protruding from the hub towards the corresponding arm and configured to be receivable in any one of the pin-receiving apertures.
17. The device of any one of embodiments 1 to 16, wherein the hub comprises at least one arms securing element having an open state, in which the first and second arm-leg assemblies are allowed to pivot between the distal positions and the proximal positions thereof, and a closed state, in which the first and second arm-leg assemblies are prevented from pivoting between the distal positions and the proximal positions thereof.
18. The device of Embodiment 17, wherein in the closed state the at least one arms securing element applies pressure on the arms so at to prevent the first and second arm-leg assemblies from pivoting.
19. The device of Embodiment 17 or 18 when dependent directly or indirectly on Embodiment 4, wherein the upper end of the front and rear hub portions are spaced from each other and form a top opening of the hub, wherein the front and rear hub portions are connected by the at least one arms securing element at the top opening, when the at least one arms securing element is in its closed state.
20. The device of any one of Embodiments 17 to 19, wherein the hub further comprises arm-spread limiting surfaces, wherein the at least one arms securing element is configured to secure the first and second arm-leg assemblies, when in their arms distal position, against the spread limiting surfaces, when in the closed state thereof.
21. The device of any one of embodiments 1 to 20, further comprising a movement transmission mechanism associated with at least one of the arms.
22. The device of embodiment 21 when dependent on embodiment 2 directly or indirectly, wherein at least a part of the movement transmission mechanism is moveable together with the corresponding arm relative to the corresponding rear leg, between an extended and a retracted state of the movement transmission mechanism corresponding to the extended and retracted states of the arms.
23. The device of any one of embodiments 1 to 22, further comprising a seat attached to the hub and to the rear legs.
24. The device of embodiment 23, wherein the seat is pivotably connectable to the hub so as to allow the seat to pivot upward and downward whereby the seat can be positioned in an operational raised orientation in which a user can sit thereon while facing in a rearward direction, and a non-operational downward orientation.
25. The device of embodiment 23 or 24 when dependent directly or indirectly from Embodiment 4, wherein the seat has a proximal connection area, at which the seat is pivotally connected to the rear hub portion and connected to the rear legs between the proximal ends and distal ends thereof by a seat lowering and raising mechanism operable to pivot the seat between the operational raised orientation, and the non-operational downward orientation in which the seat is in a non-operational orientation.
26. The device of embodiment 25, wherein the seat comprises a central seat portion; right and left side foldable seat wings, pivotably connected to the central seat portion along side wing pivot axes extending between a proximal edge and a distal edge of the seat; and the seat lowering and raising mechanism is operable to bring the seat wings from a seat unfolded state in which the wings are aligned with the central seat portion in an operational orientation of the seat, into a seat folded state in which the wings are pivoted relative to the central seat portion and form an angle therewith when the seat is in a non-operational orientation.
27. The device of any one of embodiments 23 to 26, wherein the seat lowering and raising mechanism is operable to bring the seat from the unfolded state into the folded state when the device is moved from its deployed state to its folded state.
28. The device of any one of embodiments 1 to 27, wherein the at least one front leg is constituted by two front legs whose distal ends are spaced apart from each other in the deployed state of the device.
29. The device of embodiment 28, wherein the two front legs comprise a two-front leg proximation mechanism configured to bring the distal ends of the two front legs into an adjacently parallel position.
30. The device of any one of embodiments 1 to 29, wherein the legs have respective wheels at their distal ends.
31. An actuation transmission mechanism for use with an extendable arm-leg assembly comprising an arm having an actuating element at an arm proximal portion and a leg having an actuatable element at a leg distal end configured to perform an actuated motion when induced at least indirectly by a corresponding actuation motion of the actuating element, the arm and the leg configured to interact in a telescopic movement manner along a longitudinal axis of the assembly, between a retracted state of the arm-leg assembly, in which a distance between the actuating and actuatable elements is of a first length, and an extended state of the arm-leg assembly, in which said distance is of a second length greater than the first length, the actuation transmission mechanism comprising at least in operation of the assembly:
at least one interconnecting structure comprising
   an arm-associated portion fixedly connected to the actuating element so as to be movable therewith during both the actuation motion and the telescopic movement, and a leg-associated portion fixedly connected to the actuatable element so as to be movable therewith during both the actuated motion and the telescopic movement, the two portions overlapping at an overlapping area having a length along said axis, which changes correspondingly to the change in said distance, and
   an interconnecting element interacting with both the arm-associated portion and the leg-associated portion at said overlapping area so as to induce the actuated motion of the actuatable element upon the actuation motion of the actuation element.
32. The mechanism of embodiment 31, wherein the interconnecting structure selectively connects the arm-associated portion and the leg-associated portion at said overlapping portion, upon the actuation of the actuating element.
33. The mechanism of embodiment 31, wherein the interconnecting element connects the arm-associated portion and the leg-associated portion only when the actuating element is being actuated.
34. The mechanism of embodiment 31, wherein the interconnecting element always connects the arm-associated portion and the leg-associated portion.
35. The mechanism of embodiment 31, wherein the leg-associated portion is constituted by a brake-movement strip comprising a series of recesses along at least a portion of the length thereof.
36. The mechanism of embodiment 31, wherein the actuatable element is constituted by a brake-pad assembly.
37. The mechanism of embodiment 36, wherein the brake-pad assembly is attached to a lower end of a brake-movement strip and comprises a brake pad configured to brakingly and reversibly interface with a wheel.
38. The mechanism of embodiment 31, wherein the interconnecting element is constituted by an intermediate brake element actuatable by the brake actuating lever and attached at an upper end thereof to the arm-associated portion constituted by a brake cable and at a lower end thereof to the leg-associated portion constituted by a brake-movement strip and comprising an opening therein and a mushroom-shaped member comprising a top and a stem, the mushroom-shaped member configured so that the top thereof is reversibly receivable in the recesses of the brake-movement strip, the stem configured to be received in the opening and reversibly fixable therein so as to fix the top in one of the recesses and allow the top to slide out from the recesses upon extension and retraction of the arm and the leg relative to each other.
39. The mechanism of embodiment 38, wherein operating the brake actuating lever moves opening causing mushroom-shaped member to be fixed in the opening and also moves the brake-movement strip thereby actuating the actuatable element.
40. The mechanism of embodiment 38, wherein the brake movement strip is configured to move longitudinally with respect to at least one of the arm and the leg.
41. The mechanism of embodiment 38, wherein the top of the mushroom-shaped member and the recesses are correspondingly shaped.
42. The mechanism of embodiment 38, wherein the mushroom-shaped member is biased toward the brake-movement strip by one or more springs whereby the top of the mushroom-shaped member enters one of the recesses of the brake element strip when the top is located opposite the recesses.
43. The mechanism of embodiment 38, wherein the opening is cam-shaped.
44. The mechanism of embodiment 31, wherein the interconnecting structure permanently connects the arm-associated portion and the leg-associated portion and is configured to change its length with respect to the change in distance between the actuating element and the actuatable element.
45. The mechanism of embodiment 31, wherein the interconnecting structure is constituted by a single cable interconnecting the actuating element and the actuatable element.
46. The mechanism of any one of embodiments 31 to 45 wherein said mechanism is incorporated within said arm-leg assembly.
47. The mechanism of embodiment 46, constituting a part of a device for use to support a user on a surface, the device comprising, at least in operation, two arm-leg assemblies each incorporating said mechanism and at least one front leg, having a proximal end; and a distal end, and wherein optionally the device is the device according to any one of embodiments 1 to 30.
48. A brake mechanism for use in an extendable arm-leg assembly comprising an arm and a leg operably and movably engaged with each other in a telescopic movement manner at least along an overlapping area of the arm-leg assembly, at least one of the arm and the leg having a hollow portion associated with the overlapping area;
the mechanism comprising:
   an actuating element constituted by a brake actuating lever connected to the arm;
   an actuatable element constituted by a brake-pad assembly connected to the leg; and
   an interconnecting structure constituted by a brake cable unit comprising an outer flexible sleeve and an inner flexible brake cable passing through said sleeve and having an arm-associated portion including one cable end attached to the brake actuating lever and a leg-associated portion including a second cable end attached to the brake-pad assembly, the outer sleeve with the inner cable therewithin that interconnects the arm-associated portion and the leg-associated portion constitutes an interconnecting element forming a loop having such dimensions as to be capable of being received within said hollow portion, wherein the length of the interconnecting element is about equal to the length of at least the overlapping area, wherein the length of the interconnecting element is variable in accordance with that of the overlapping area.
49. The mechanism of embodiment 48 wherein said mechanism is incorporated within said arm-leg assembly.
50. The mechanism of embodiment 49, constituting a part of a device for use to support a user on a surface, the device comprising, at least in operation, two arm-leg assemblies each incorporating said mechanism and at least one front leg, having a proximal end and a distal end, the device being optionally according to any one of embodiments 1 to 30.
51. A front leg deployment and folding mechanism for use in a device, for supporting a user on a surface, the device comprising, at least in use, a hub, at least one front leg and a pair of rear legs, the front and rear legs having respective proximal ends being associated with the hub, and distal ends spaced from the hub towards said surface when the device is positioned thereon, the rear legs being moveable between rear legs distal position and rear legs proximal position; wherein the mechanism is configured to be at least partially mounted within said hub so as to manipulably interconnect the proximal ends of the at least one front leg and of the rear legs to selectively induce movement of the at least one front leg in response to the movement of the rear legs to move the at least one front leg towards a front leg distal position when the rear legs are moved towards their distal position and towards a front leg proximal position when the rear legs are moved towards in their proximal position.
52. The mechanism of embodiment 51, wherein in the proximal position of the front and rear legs, the at least one front leg is at least partially located between the rear legs.
53. The mechanism of embodiment 52, wherein in the proximal position of the front and rear legs, the distal end of the at least one front leg is located rearwards to the rear legs.
54. The mechanism of any one of embodiments 51 to 53, comprising at least one rear leg transmission gear fixed to a proximal portion of at least one of the rear legs, and at least one front transmission gear to which the proximal end of the at least one front leg is operably connected, the at least one front leg transmission gear being disposed so as to mesh with the at least one rear leg transmission gear, such that movement of the rear legs toward their proximal or distal positions rotates the at least one rear leg transmission gear causing the at least one front leg transmission gear to rotate the at least one front leg.
55. The mechanism of any one of embodiments 51 to 54, further comprising at least one front leg transmission element to which the proximal end of the at least one front leg is connected, such that movement of the rear legs toward their proximal or distal positions rotates the at least one rear leg transmission gear causing the at least one front leg transmission gear to rotate the at least one front leg transmission element rearward or forward, respectively, and thereby the at least one front leg connected thereto.
56. The mechanism of any one of embodiments 51 to 55, wherein the mechanism is configured to urge and secure the front leg in place, whether in the folded or deployed state.
57. The mechanism of any one of embodiments 51 to 56 wherein said mechanism is incorporated within said device and wherein, optionally, the device is according to any one of the embodiments 1 to 30.
58. The mechanism of embodiment 57, wherein each of the legs of the pair of rear legs, constitute a part an arm-leg assembly with a corresponding arm thereby forming a pair of arm-leg assemblies.
59. The mechanism of embodiment 58, wherein the pair of arm-leg assemblies is pivotably connected to the hub so as to enable the front and rear legs with their corresponding arms to pivot between the distal positions thereof and the proximal positions thereof, the proximal position of the legs being achieved by moving the right and left arms from an arms distal position in which the arms are spread apart, to an arms proximal position in which a distal end of each of the arms is closer to the other distal end than in the arms distal position.
60. A deployable hung seat assembly for a device for use to support a user on a surface, the device comprising at least one front leg, a right rear leg and a left rear leg, each leg having a proximal end; and a distal end in which the distal end of each leg may directly contact said surface, and a hub to which the front leg and the right and left rear legs are pivotably connected so as to enable the front and rear legs to pivot between distal positions thereof and proximal positions thereof, said seat assembly comprising:
a seat having a front seat edge and a rear seat edge, attachable to the device pivotable about a seat pivot axis between a seat deployed, raised orientation and seat storage, lowered orientation in which the front seat edge is disposed closer to the right and left rear legs than in the raised orientation and lower than the rear seat edge in a front view; and
a seat lowering-raising mechanism comprising a foldable support element having an upper portion hingebly connected at least indirectly to the seat in the vicinity of the front seat edge about an upper pivot axis, and a lower portion hingedly joined to the upper portion about a folding hinge axis, and hingebly connected at least indirectly to the right and left legs at a location lower than the upper pivot axis in the front view of the assembly, the foldable support element is manipulable between a supporting state, in which the upper portion and lower portion are prevented from hinging with respect to each other, are aligned along a single plane, and are oriented so as to support the seat in the deployed, raised orientation, and a foldable state, in which the upper portion and lower portion are allowed to hinge with respect to each other and the seat is allowed to pivot into its storage, lowered orientation; and
a locking arrangement operable between a locking state in which the upper portion and lower portion are prevented from hinging with respect to each other and a releasing state in which the upper portion and lower portion are allowed to hinge with respect to each other and the seat is allowed to pivot into its storage, lowered orientation.
61. The seat assembly of embodiment 60, wherein the seat comprises right and left side foldable wings pivotably connected thereto by at least one pivot axle extending along the side wing pivot axis normal to the seat pivot axis and extending from the front seat edge to the rear seat edge.
62. The seat assembly of embodiment 61, wherein the seat comprises a central seat portion, to which the right and left side foldable wings are pivotably connected by right and left pivot axles extending along corresponding side wing pivot axes, wherein the right and left foldable side wings are pivotable between a wing deployed position, in which the right and left foldable side wings are on the same plane as the central seat portion and a wing folded position, in which the right and left foldable side wings are angled to the central seat portion so as to reduce the profile of the seat.
63. The seat assembly of embodiment 61 or embodiment 62, wherein the upper portion of the foldable support element is hingebly connected to both the right and left foldable side wings such that upon folding of the foldable support element the right and left foldable side wings will fold inward towards it.
64. The seat assembly of any one of embodiments 61 to 63 wherein the seat lowering-raising mechanism is configured to be disposed between the right and left foldable wings when the seat is folded.
65. The seat assembly of any one of embodiments 60 to 64 wherein the upper portion and the lower portion are hingedly joined at the side of the foldable support element facing away from hub.
66. The seat assembly of any one of embodiments 60 to 65, wherein each of the right and left legs further comprises a ball joint connection and wherein the lower portion is articulably connected to the right and left legs by right and left adjustment members that are articulably connected the ball joint connections of said right and left legs, respectively.
67. The seat assembly of any one of embodiments 60 to 66, wherein said assembly is connected to said device so as to constitute an integral part thereof at least when the device is in use, and optionally, wherein said device is according to any one of embodiments 1 to 30.
68. The seat assembly of embodiment 67, wherein each of the right and left legs constitute a part of an arm-leg assembly with corresponding right and left arms, thereby forming a pair of right and left arm-leg assemblies.
69. The seat assembly of embodiment 68, wherein the pair of arm-leg assemblies is pivotably connected to the hub so as to enable the front and rear legs with their corresponding arms to pivot between the distal positions thereof and the proximal positions thereof, the proximal position of the legs being achieved by moving the right and left arms from an arms distal position in which the arms are spread apart, to an arms proximal position in which a distal end of each of the arms is closer to the other distal end than in the arms distal position.
70. The seat assembly of Embodiment 67, wherein the device further comprises a front leg deployment and folding mechanism disposed within the hub; and is configured to manipulably interconnect the proximal ends of the at least one front leg and of the right and left rear legs to selectively induce movement of the at least one front leg in response to movement of the right and left rear legs so as to move the at least one front leg towards a front leg distal position when the rear legs are moved towards their distal position and towards a front leg proximal position when the rear legs are moved towards in their proximal position.
71. The seat assembly of Embodiment 67, the device further comprising a brake mechanism incorporated within at least one of said arm-leg assemblies in which the arm and the leg are operably and movably engaged with each other in a telescopic manner at least along an overlapping area of the arm-leg assembly, at least one of the arm and the leg having a hollow portion associated with the overlapping area;
the mechanism comprising:
an actuating element constituted by a brake actuating lever connected to the arm;
an actuatable element constituted by a brake-pad assembly connected to the leg; and
an interconnecting structure constituted by a brake cable unit comprising an outer flexible sleeve and an inner flexible brake cable passing through said sleeve and having an arm-associated portion including one cable end attached to the brake actuating lever and a leg-associated portion including a second cable end attached to the brake-pad assembly, the outer sleeve with the inner cable therewithin that interconnects the arm-associated portion and the leg-associated portion constitutes an interconnecting element forming a loop having such dimensions as to be capable of being received within said hollow portion, wherein the length of the interconnecting element is about equal to the length of at least the overlapping area, wherein the length of the interconnecting element is variable in accordance with that of the overlapping area.
72. The seat assembly of Embodiment 71, wherein the mechanism further comprising a seat state indication element operably connecting the brake-pad assembly to the seat lowering-raising mechanism, the seat state indication element is configured to actuate the brake-pad assembly when the seat is in its supporting state.
73. A rollable device, for supporting a user on a surface, the device comprising at least in use a hub having a reference plane normal to the surface, two first legs, located on different sides of the reference plane and at least one second leg, the first and second legs each having respective proximal ends disposed within the hub and distal ends having wheels operably connected thereto and spaced from the hub towards said surface when the device is positioned thereon, at least one of the first legs is moveable between a retracted position, in which it is spaced from the reference plane to a first distance and a deployed position, in which it is spaced from the reference plane to a second distance larger than the first distance; each of the first legs being provided with an orientation maintaining structure comprising an elongated wheel connector configured to be maintained parallel to the reference plane in both the distal and proximal positions of the corresponding first leg.
74. The device of Embodiment 73, wherein the orientation maintaining structure further comprises a balancing rod extending parallel to the corresponding first leg and having a proximal rod end pivotally connected, at least indirectly, to the hub and a distal rod end, and the elongated wheel connector comprises a first connector end pivotally connected to the distal end of the corresponding first leg, and a second connector end pivotally connected to the distal end of the balancing rod.
75. The device of Embodiment 74, wherein the orientation maintaining structure further comprises a parallelogram forming link having a first portion to which the corresponding first leg is pivotally connected adjacent the proximal end of the leg, and a second portion to which the balancing rod is pivotally connected adjacent the proximal end of the balancing rod, the distance between the first portion and second portion is about same to the distance between the distance between the first connector end and the second connector end of the elongated wheel connector, thereby forming a parallelogram structure.
76. The device of Embodiment 75, wherein each of the first legs has the orientation maintaining structure with the first wheel link and the balancing rod, and optionally, wherein the first legs constitute front legs of the device with said reference plane being a vertical plane of symmetry passing between said front legs, and wherein optionally, the device is according to any one of embodiments 1 to 30.
77. The device of Embodiment 75 or 76, wherein when the device is positioned on said surface, the end of the first wheel link at which the wheel is connected to the corresponding first leg is spaced from said surface to a longer distance than the end at which the first wheel is connected to its balancing rod.
78. The device of any one of Embodiments 73 to 77, wherein the device further comprises the front leg deployment and folding mechanism of any one of embodiments 51 to 59.
79. The device of Embodiment 78, when dependent directly or indirectly on Embodiment 75, wherein the parallelogram forming link constitutes the front leg transmission element of Embodiment 55.
80. A device for supporting a user on a surface at least during movement in a frontward direction, the device comprising: at least two arms and a number of legs having wheels, at least one of said arms having a handle connected to the arm at a handle proximal end and having a free handle distal end spaced rearwardly from the arm, the handle having such a length so as to allow said user to at least partially grasp said handle at a location spaced from the handle proximal end; and at least one brake mechanism associated with said at least one of said arms, said brake mechanism comprising a brake actuating lever, and a brake assembly operably connecting said brake actuating lever to at least one of said wheels to allow selectively preventing the at least one wheel from rotating, said brake actuating lever having a distal lever end connected to the handle adjacent the free handle distal end, the lever having a free proximal lever end frontwardly spaced from the handle distal end, the proximal lever end being movable by a user, to operate said braking mechanism, by applying to the proximal lever end, a force, at least indirectly, while grasping said handle.
81. The device of Embodiment 80, wherein a projection of the proximal end of the lever onto the handle is spaced from the handle distal end to a distance of at least one third, optionally at least half of the length of the handle between the distal and proximal ends thereof.
82. The device of Embodiment 80 or 81, wherein said handle comprises a lever holding interface adjacent the free handle distal end, and said lever comprises a lever distal end connected to said lever holding interface, wherein the distal ends of the rear legs are spaced rearwardly from said lever holding interface at least in a side view of the device.
83. The device of any one of Embodiments 80 to 82, wherein the handle comprises a lower surface facing the surface on which the user is supported and an opposing upward-facing surface shaped to support a portion of the user's hand when grasping the handle, the brake-actuating lever being operatively connected to the lower surface of the handle.
84. The device of any one of Embodiments 80 to 83, wherein said at least two arms comprise two arms, each arm comprising said handle and said brake-actuating lever operably connected to a respective braking mechanism.
85. The device according to any one Embodiments 80 to 84, wherein at least one of said arms and one of said legs constitute an extendable arm-leg assembly, wherein said arm and leg are operably and movably engaged with each other in a telescopic movement manner at least along an overlapping area of the arm-leg assembly, at least one of the arm and the leg having a hollow portion associated with the overlapping area; wherein said braking assembly comprises an actuatable element constituted by a brake-pad assembly connected to the leg; and an interconnecting structure constituted by a brake cable unit comprising an outer flexible sleeve and an inner flexible brake cable passing through said sleeve and having an arm-associated portion including one cable end attached to the brake actuating lever and a leg-associated portion including a second cable end attached to the brake-pad assembly, the outer sleeve with the inner cable therewithin that interconnects the arm-associated portion and the leg-associated portion constitutes an interconnecting element forming a loop having such dimensions as to be capable of being received within said hollow portion, wherein the length of the interconnecting element is about equal to the length of at least the overlapping area, wherein the length of the interconnecting element is variable in accordance with that of the overlapping area.
86. The device according to Embodiment 85, wherein said mechanism is incorporated within said arm-leg assembly.
87. A device for use to support a user on a surface, the device comprising, at least in operation: at least one front leg, a right rear leg and a left rear leg, each leg having a proximal end and a distal end, wherein the distal end of each leg may directly contact said surface; a right arm having a distal end and a proximal end, the right arm engaging the left rear leg, thereby constituting a first arm-leg assembly; a left arm having a distal end and a proximal end, the left arm engaging the right rear leg, thereby constituting a second arm-leg assembly; a hub to which the first and second arm-leg assemblies are pivotably connected so as to enable the front and rear legs with the corresponding arms to pivot between distal positions thereof and proximal positions thereof, the distal ends of the legs being closer to each other in the proximal position than in the distal position of the legs, and the proximal position of the legs being achieved by moving the right and left arms from an arms distal position in which the arms are spread apart, to an arms proximal position in which the distal ends of the arms are closer to each other than in the arms distal position, whereby the device can be brought from a deployed state in which the arms and the rear legs are in their distal positions, into a folded state in which the arms and the rear legs are in their proximal position; at least one arms securing element attached to the hub so as to be movable between an open state, in which the first and second arm-leg assemblies are allowed to pivot between the distal positions and the proximal positions thereof, and a closed state, in which the first and second arm-leg assemblies are prevented from pivoting between the distal positions and the proximal positions thereof; and a securing element handle protruding from at least said arm securing element in a direction away from the hub in the closed position of the arm securing element.
88. The device according to Embodiment 87, wherein the right arm is slidingly moveable with respect to the left rear leg and the left arm is slidingly moveable with respect to the right leg, each arm slidable between an extended state in the deployed state of the device; and in which the distal ends of the arms are spaced from the hub, and a retracted state which the arms have in the folded state of the device and in which the distal ends of the arm are disposed adjacent to the hub, and wherein said securing element, when in the open state, allows the arms to move between the extended state and the retracted state, and when the closed state, prevents the arm from moving from the retracted state into the extended state.
89. The device according to Embodiment 88, wherein the hub comprises front and rear hub portions spaced from each other by a top opening of the hub, wherein when the at least one arms securing element is in its closed state, the front and rear hub portions are connected by the arms securing element at the top opening, and the handle protrudes from the arm securing element in the direction away from the top opening.
90. The device according to Embodiment 89, wherein the arms-securing element has a proximal end connected to the hub and a distal end comprising a locking component, said hub further comprising a locking component receiving portion configured to lockingly engage the locking component when the arms-securing element is in its closed state, such that the locking engagement remains locked even when the device is lifted by a lifting force applied to the handle.
91. The device according to Embodiment 90, wherein said locking component is constituted by a locking protrusion, and said locking component receiving portion comprises a notch shaped to receive the locking protrusion.
92. The device according to Embodiment 91, wherein said arm securing element comprises two opposite arm-interfacing faces along the length thereof each configured to press on one of the respective arms.
93. The device according to Embodiments 92, wherein said two arm-interfacing faces are spaced apart along the length of the arm securing element.

It is noted that the terms “front” and “rear” are relative terms and should be understood as reversible, or even as right and left sides, depending on orientation and/or possible movement of the platform.

### BRIEF DESCRIPTION OF THE DRAWINGS

The presently disclosed subject matter may be more clearly understood upon reading of the following detailed description of non-limiting exemplary embodiments thereof, with reference to the following drawings, in which:

FIGS. 1A-1C are, respectively, perspective, front and side views of a platform, exemplified by a rollator in accordance with one example of the presently disclosed subject matter, in a deployed/unfolded state.

FIGS. 2A-2C are perspective, front and side views of the rollator of FIGS. 1A-1C in a folded state.

FIGS. 3A-3C are perspective, front and side views of the rollator of FIGS. 1A-1C in a partially folded state.

FIG. 4 is a side view of an arm-leg assembly which can be used in a platform, according to the presently disclosed subject matter.

FIGS. 5A-5I are various views of a hub, which can constitute a part of a platform, according to the presently disclosed subject matter.

FIGS. 5J-5N are various views of another hub, which can constitute a part of a platform, according to the presently disclosed subject matter.

FIGS. 5P and 5Q are perspective and side views of an arms securing element handle and an arm securing element in the open and closed states thereof, respectively, according to one example of the presently disclosed subject matter.

FIG. 6 is a perspective internal view of an exemplary height limiting mechanism according to the presently disclosed subject matter.

FIGS. 7A-7B are perspective views of an exemplary front leg deployment and folding mechanism according to the presently disclosed subject matter.

FIGS. 8A-8D are various views illustrating a first exemplary movement transmission mechanism, which a platform having an arm-leg assembly of the kind shown in FIG. 4 can have, according to the presently disclosed subject matter.

FIGS. 9A-9E are various views of a seat deployment mechanism, which a platform according to the presently disclosed subject matter can be provided with.

FIGS. 10A-10B are perspective views of a seat with seat-wings, which a platform according to the presently disclosed subject matter can be provided with.

FIGS. 10C is a perspective view illustrating an example of a movement transmission mechanism of a platform with a seat state indication element according to the presently disclosed subject matter, FIG. 10D being an enlargement of area BB of FIG. 10C when the seat is in its folded state and FIG. 10E being an enlargement of area BB of FIG. 10C when the seat is in its deployed state.

FIGS. 11A-11C are respectively perspective, side and rear views of a platform exemplified by a rollator, according to another example of the presently disclosed subject matter, in a deployed/unfolded state.

FIGS. 12A-12C are perspective, side and rear views of the rollator of FIGS. 11A-11C, in a folded state.

FIGS. 13A-13C are perspective, side and rear views of the rollator of FIGS. 11A-11C in a partially folded state.

FIGS. 14A-14D are side views of a second exemplary brake mechanism, which an arm-leg assembly of the kind shown in FIG. 4 can have, according to the presently disclosed subject matter, in which FIG. 14A is an edge view; FIG. 14B illustrates a deployed/unfolded state; FIG. 14C illustrates a partially deployed state; and FIG. 14D depicts a folded/collapsed state.

FIGS. 15A-15E are various views of the platform, exemplified by a tricycle, in accordance with an example of the presently disclosed subject matter, where FIGS. 15A-15C are respectively perspective, side and top views in a deployed/unfolded state; and FIGS. 15D-15E are respectively perspective and top views in a folded/collapsed state.

FIGS. 16A-16E are various views of a platform, exemplified by a stroller, in accordance with an example of the presently disclosed subject matter, where FIGS. 16A-16C are respectively perspective, side and top views in a deployed/unfolded state; and FIGS. 16D-16E are respectively perspective and side views in a folded/collapsed state.

FIG. 17 is an exploded perspective view of a hubless wheel, which can be used in a platform, according to the presently disclosed subject matter.

FIGS. 18A-18D are perspective views illustrating an example of a front leg separation mechanism usable with a platform, according to the presently disclosed subject matter, FIG. 18B being an enlargement of area AA of FIG. 18A.

FIGS. 19A-19B are front views illustrating another example of a front leg separation mechanism usable with a platform, according to the presently disclosed subject matter, FIG. 19B being an enlargement of area 19B of FIG. 19A.

FIG. 20A is a perspective views illustrating yet another example of a front leg separation mechanism usable with a platform, according to the presently disclosed subject matter.

FIG. 20B is a perspective views illustrating an enlargement of area 20B of FIG. 20A, with the hub removed therefrom for illustration purposes.

FIGS. 20C and 20D are side views illustrating the front leg separation mechanism is a deployed and retracted positions thereof.

FIG. 21A illustrates a perspective view of a device exemplified by a rollator, according to yet another example of the presently disclosed subject matter.

FIG. 21B illustrates a cut-away side view of a handle and brake actuating lever according to one example of the presently disclosed subject matter.

The following detailed description of embodiments of the presently disclosed subject matter refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS

Illustrative examples of movement platforms/devices according to the presently disclosed subject matter, such as rollators, tricycles, and strollers, for supporting a person on a surface, are described below. In the interest of simplicity, not all features/components of an actual implementation are necessarily described.

In below examples, a movement platform of the presently disclosed subject matter is considered to have a reference plane which, in use is normal to a surface, which the platform is to be used on, vertically crossing the platform so as to divide it into right and left lateral halves. Thus, the movement platform comprises at least one front leg, right and left rear legs and right and left arms, where each arm forms an assembly with an opposite leg. The arm-leg assemblies can be pivotally connected to the platform so as to pivot between proximal positions, in which the arms and legs of the arm-leg assemblies are at a first distance from each other, and distal positions, in which the arms and legs of the arm-leg assemblies are at a second distance from each other greater than the first distance. Thus, the device can be configured with a relatively narrow cross section when the arm-leg assemblies are in their proximal positions, and have a stable base when in their distal positions.

In the proximal position of the arm-leg assemblies, each leg of the right and left rear legs can be, at least with the majority thereof, in its side of the reference plane. Also, in the distal position of the arm-leg assemblies, each arm of the right and left arms can be, at least with the majority thereof, positioned in the opposite side of the reference plane. In some cases, the arm-leg assemblies cross when in the distal position of the arm-leg assemblies, such that each arm can be used to lever its corresponding leg to its distal location upon movement towards the proximal position thereof. The movement of the legs from their proximal position to their distal position, can occur only laterally (i.e., along an axis normal to the reference plane), or along an axis angled thereto towards the rear of the movement platform.

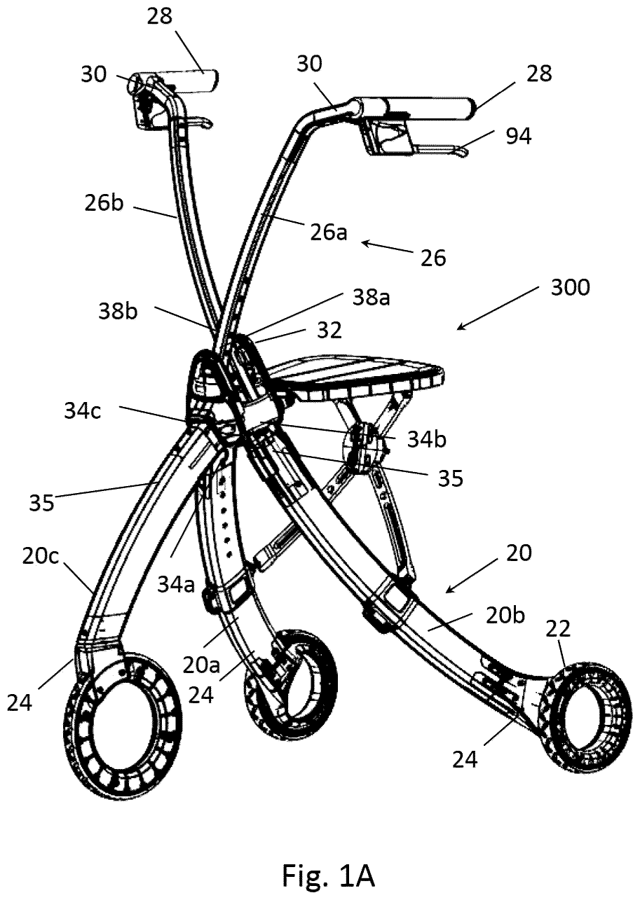

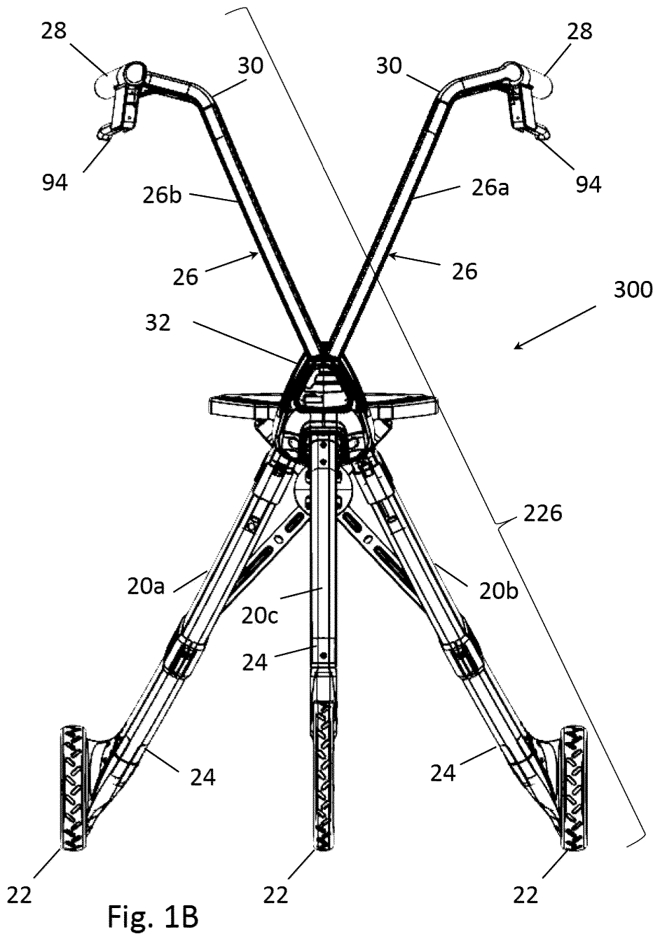

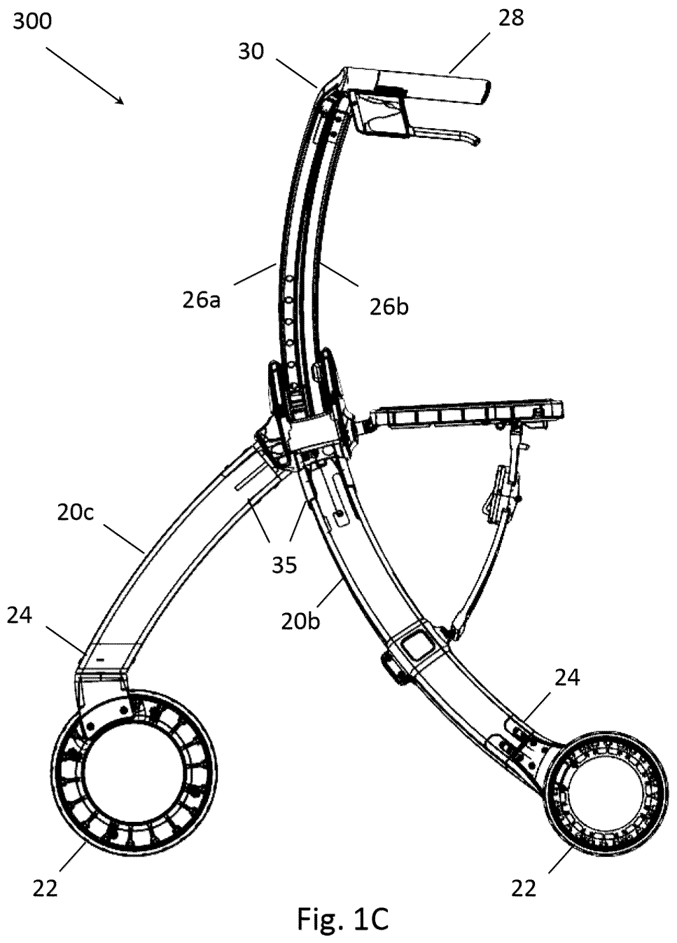

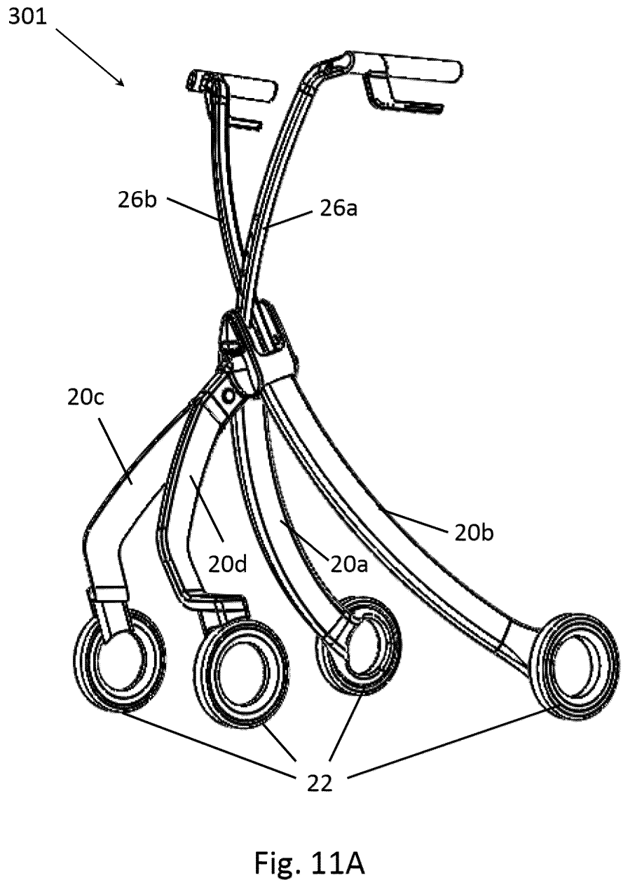

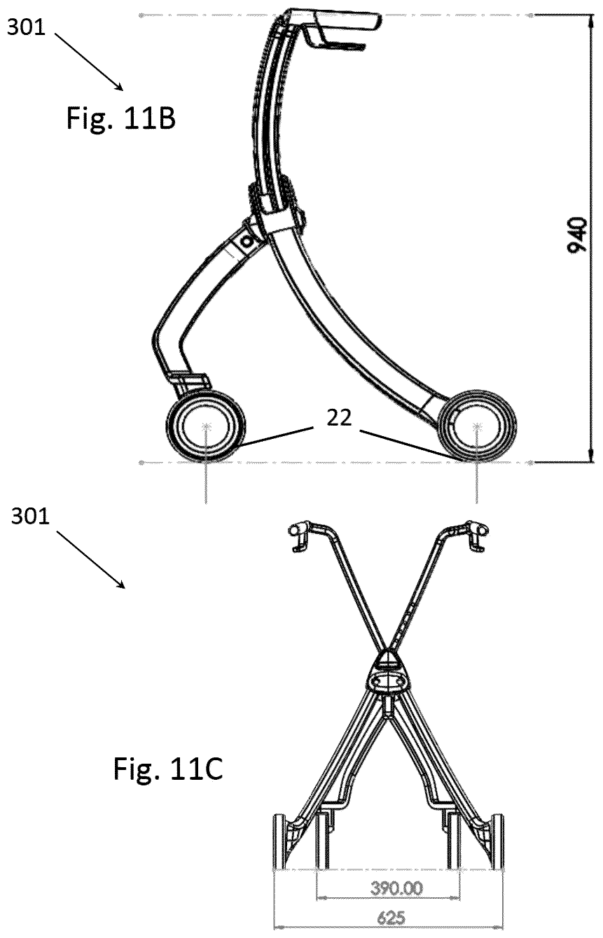

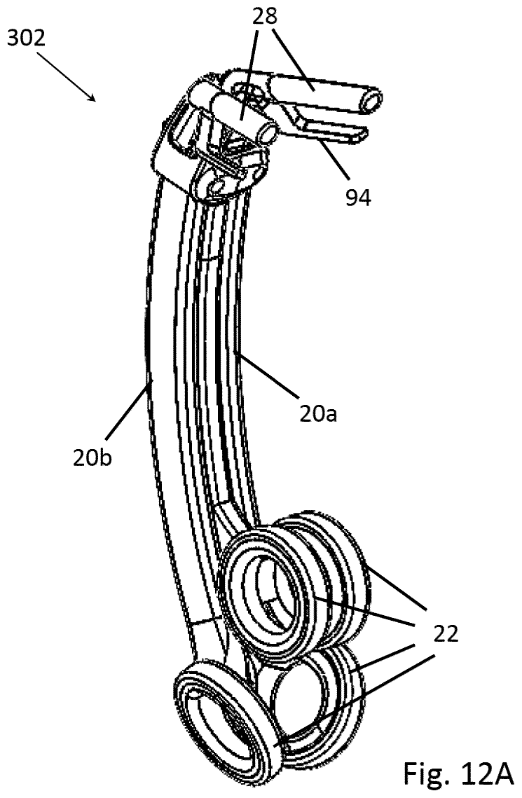

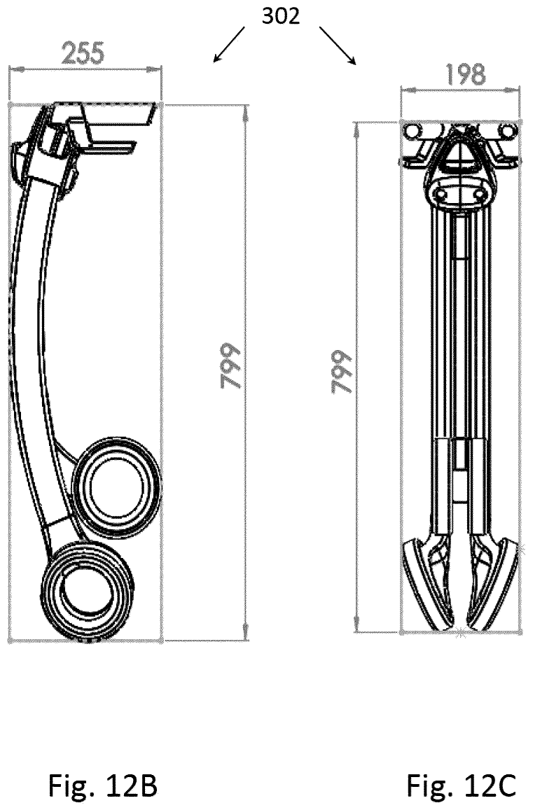

FIGS. 1A-1C show one example for such platform embodied as a rollator 300 in a deployed state. Rollator 300 includes three legs, these legs being front and rear legs 20, namely a right rear leg 20a, a left rear leg 20b, and a single front leg 20c, with wheels 22 at their distal (free) ends 24; and also includes arms 26, namely a left arm 26a and a right arm 26b, with handles 28 at their distal (free) arm portions 30. A rollator 301, shown in FIGS. 11A-11C, also has a left arm 26a, a right arm 26b and legs 20, which include two front legs 20c, 20d. Where the description below refers only to rollator 300, it should be seen as applicable also to rollator 301, unless indicated otherwise. A rollator 302, shown in FIGS. 12A-12C, also has a left arm 26a, a right arm 26b and legs 20, which include a single front leg 20c with two wheels 22 attached thereto, for increased stability.

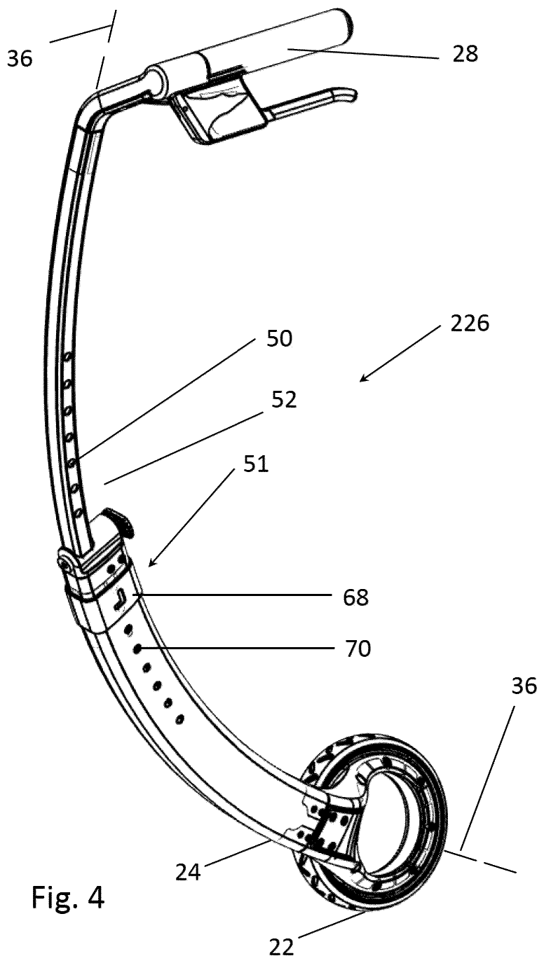

Left arm 26a of rollators 300, 301 operably engages with the right rear leg 20a, and the right arm 26b of the rollator operably engages with left rear leg 20b, thereby respectively constituting two arm-leg assemblies 226—a first or left arm assembly 226a and a second or right arm assembly 226b (FIG. 4). Each arm-leg assembly 226 has a center-line longitudinal axis 36.

In general, each arm-leg assembly can comprise a height changing mechanism such that the overall height of the arm leg assembly can be extended or reduced to fit taller or shorter users of the platform. In some cases, each arm can be received by the leg, either in an inner portion or an external portion thereof. In further cases, the arm can be slidably connected to the leg in a telescopic manner so as to extend from being about fully inserted within the leg to almost fully pulled from the leg. The arm-leg assembly can be curved such that the distal end of the leg will be rearward to the distal end of the arm, when seen from a side view of the platform.

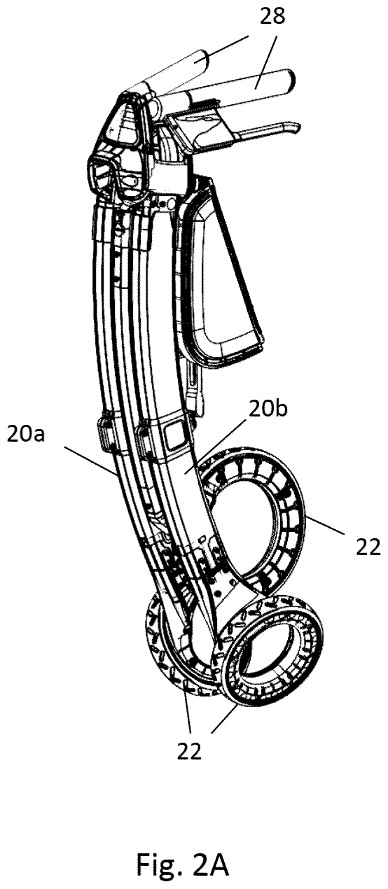

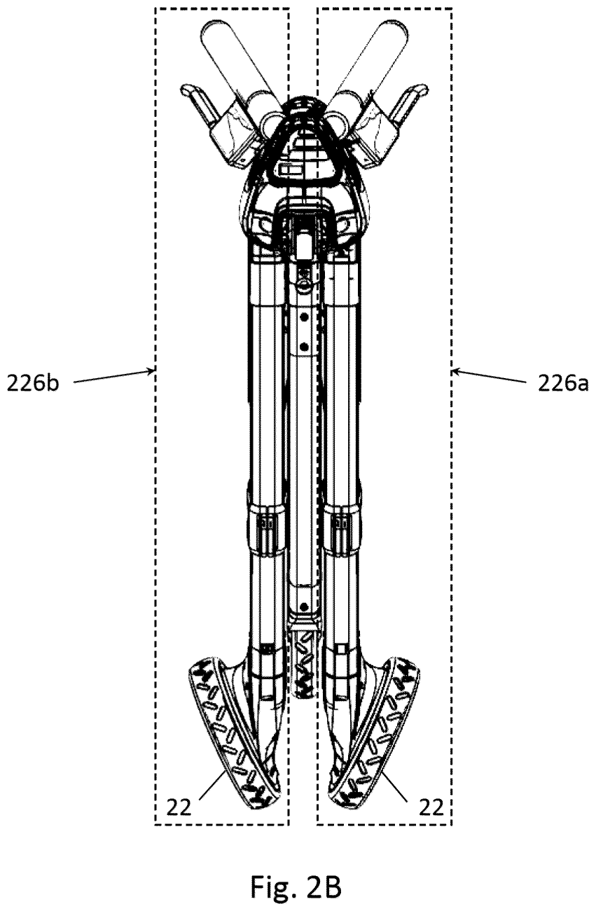

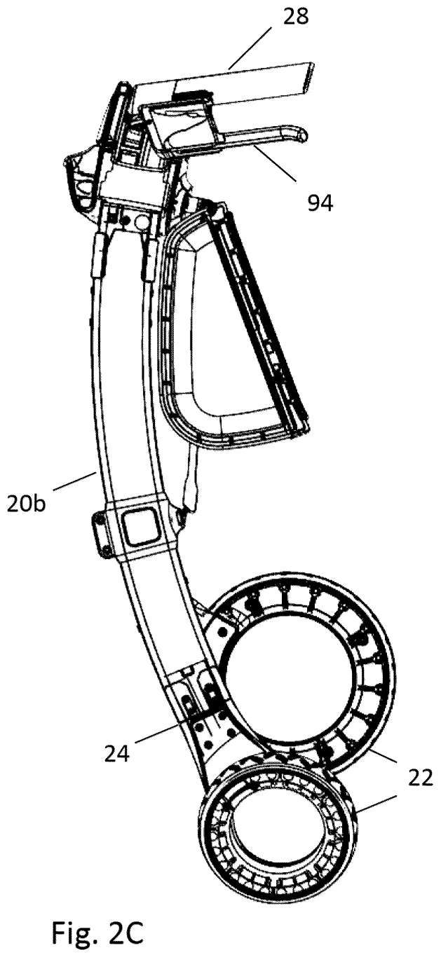

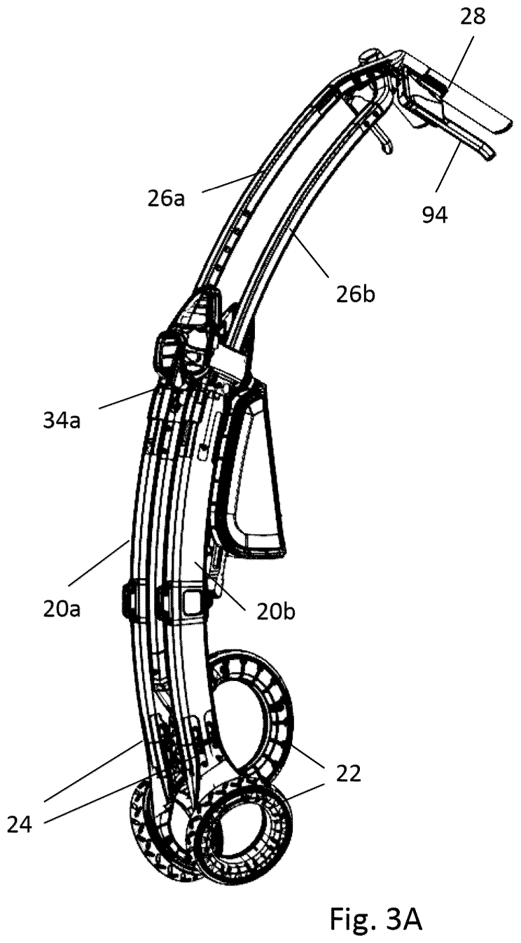

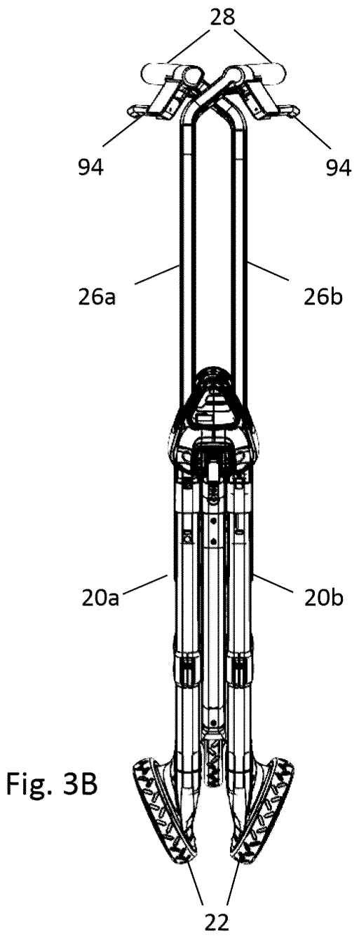

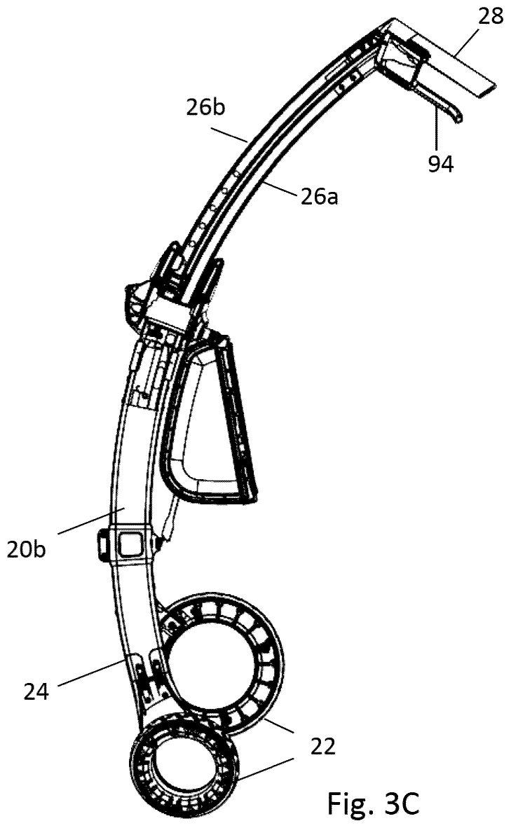

In the illustrated example, the arms 26 of both rollators 300 and 301, are curved. As shown, the arms 26 have their upper, distal arm portions 30 extending rearwardly relative to proximal ends 34 (respectively, proximal ends 34a and 34b) of proximal portions 35 of the corresponding rear legs 20a and 20b (front leg 20c also has a proximal portion 35). Rear legs 20a, 20b are curved accordingly so that respective curved arms 26 slidingly align with the legs or be received therein. Front leg(s) 20c, 20d is/are also curved so as to allow its/their alignment with the curved rear legs 20 when all legs are in their proximal position (as in FIGS. 2A-2C and FIGS. 11A-11C), illustrating a fully folded (collapsed) position; and FIGS. 3A-3C and FIGS. 12A-12C, illustrating a partially folded position).

Thus, each arm-leg assembly 226 can be connected to a hub 32 so that its center-line longitudinal axis 36 (FIG. 4) passes through the corresponding proximal end of the corresponding rear leg and through the hub 32. In the present example, the center-line longitudinal axis 36 is curved respectively to the curvature of the arm-leg assembly 226. In other cases, the center-line longitudinal axis can be straight.

In general, the Hub can have such a configuration as to allow the arm-leg assemblies to pivot between their crossed and parallel states, respectively, as illustrated in FIGS. 1B, 3B and 5A to 5G, and will be further elaborated hereinbelow.

The hub can also be configured with fastening means for securing the legs in either one of their positions for providing stability in the opened, distal position and preventing spontaneous opening of the legs in the closed, proximal position thereof.

FIGS. 2A-2C show rollator 300 and FIGS. 11A-11C show rollator 301 in their fully folded state/position. Rollators 300, 301 can also have a number of partially folded states and a deployed, crossed state. One of the partially folded states is shown in respective FIGS. 3A-3C and 12A-12C, which in the present examples constitute a transition state between the deployed and fully folded (collapsed) states of the rollators.

Within hub 32 of the present example, the proximal ends 34 (34a and 34b) of rear legs 20a and 20b are rotatably connected thereto. Also within hub 32, lower, proximal portions 38 (38a and 38b) of respective arms 26a, 26b engage the upper, proximal ends of their respective rear legs to extend upwardly therefrom and cross above the proximal ends of the rear legs when arm-leg assemblies 226 are in their deployed state. An upper, proximal end 34c of front leg(s) 20c, 20d is also disposed within hub 32.

The Hub can be a key to a number of mechanisms, some optional, for the function of the rollator. Such mechanisms may relate to features including arm-spread limiting; arm-height fixing; reducing or eliminating arm shaking and securing the arms in either or both of their positions, auto-extension and auto-retracting/folding of the front leg(s).

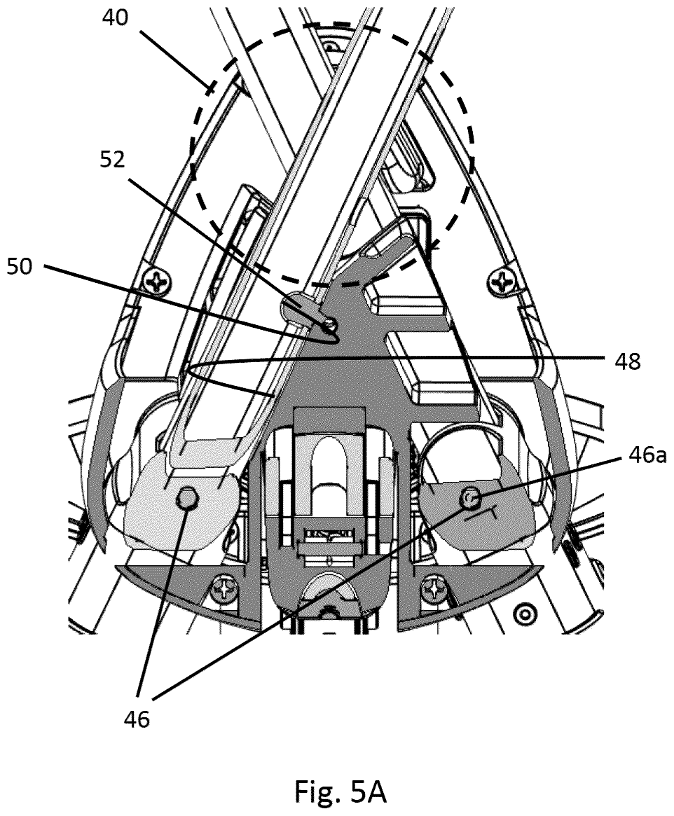

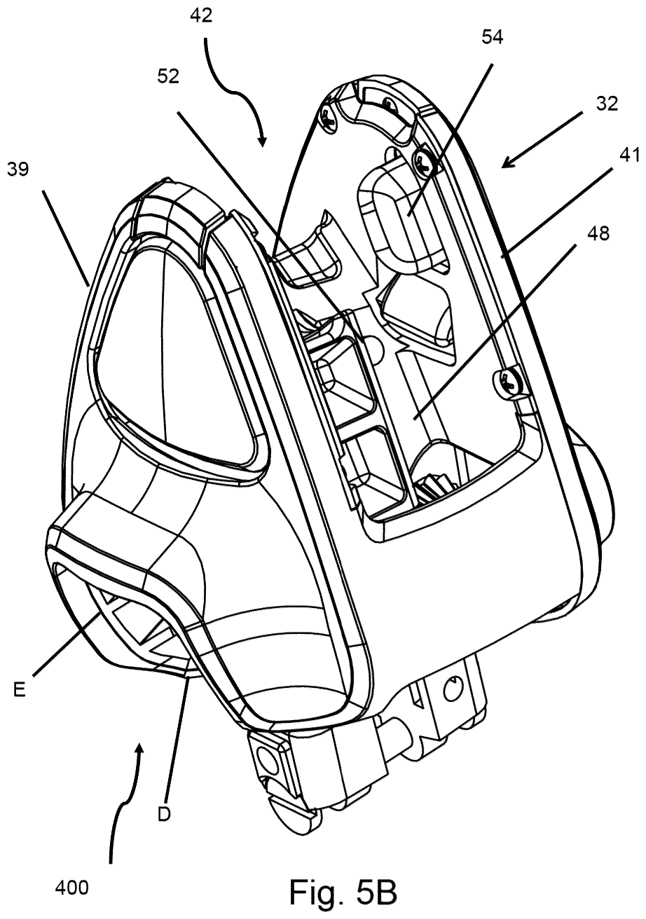

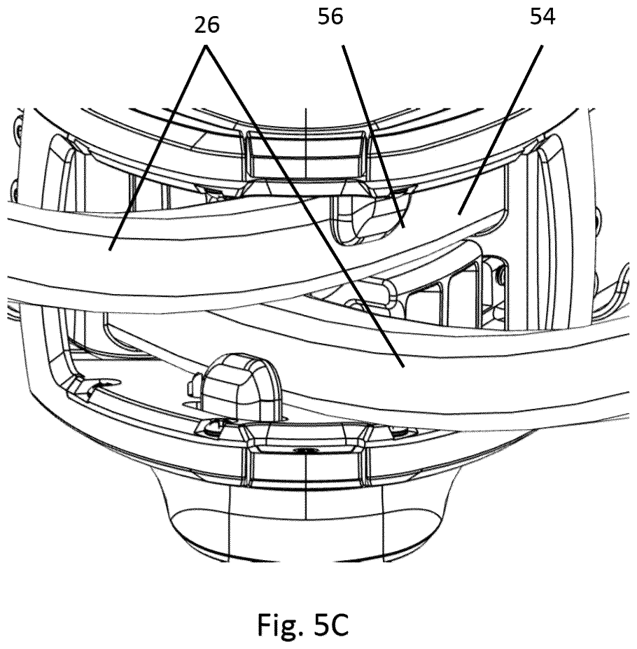

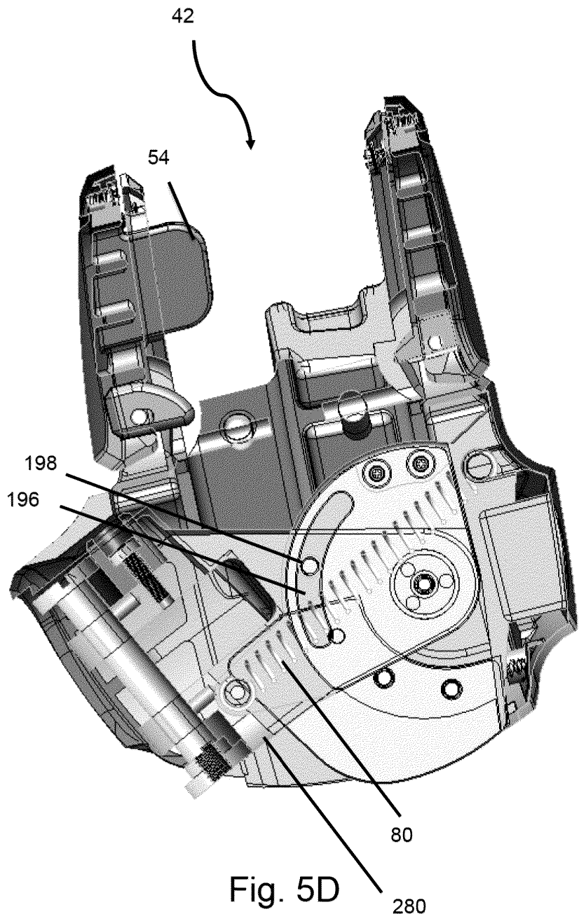

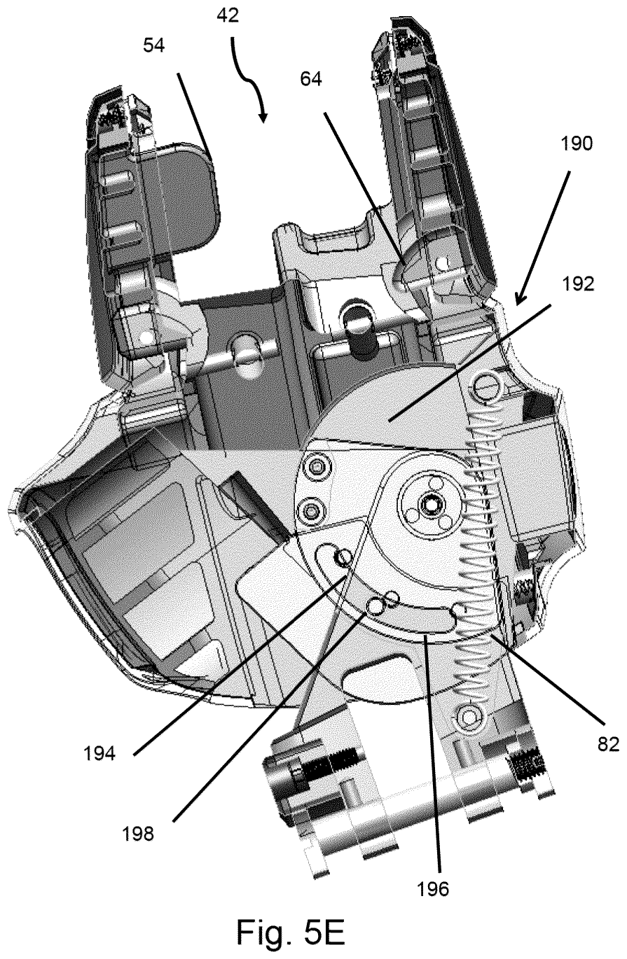

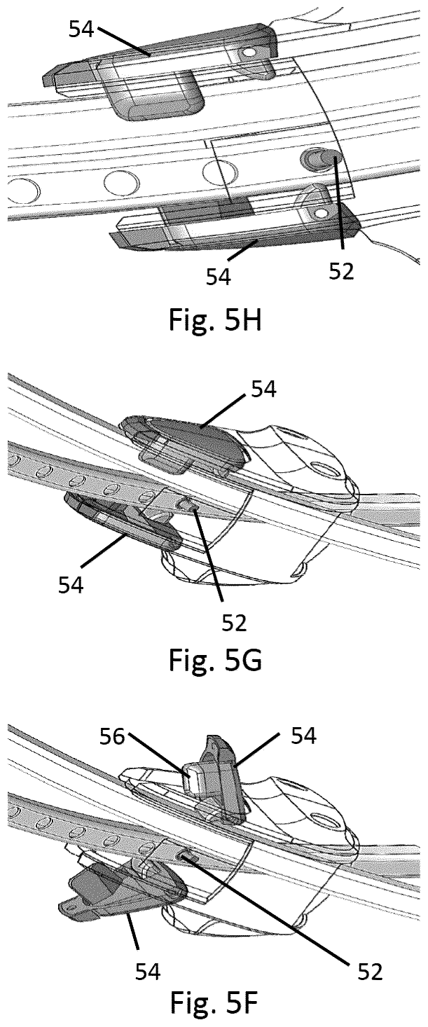

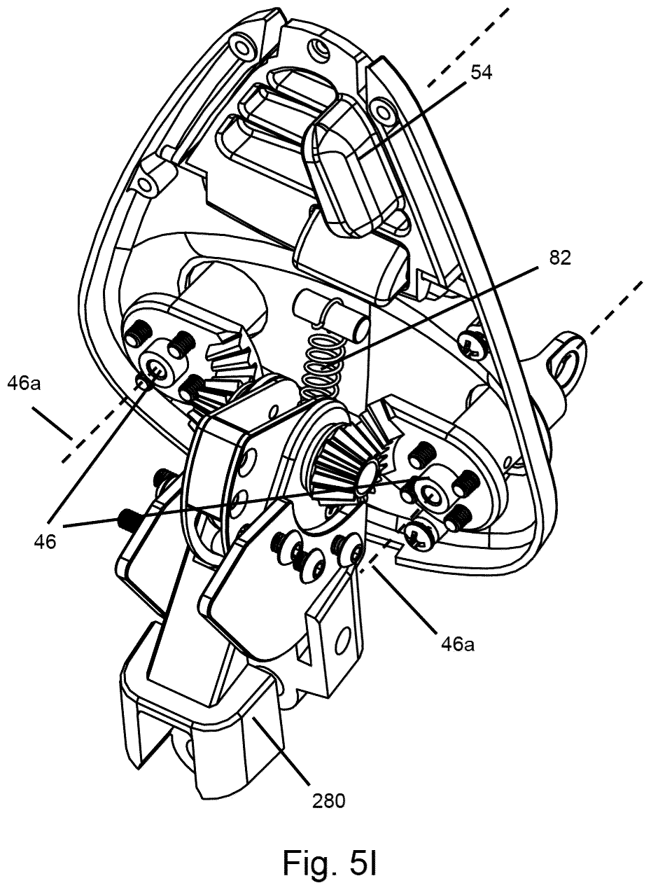

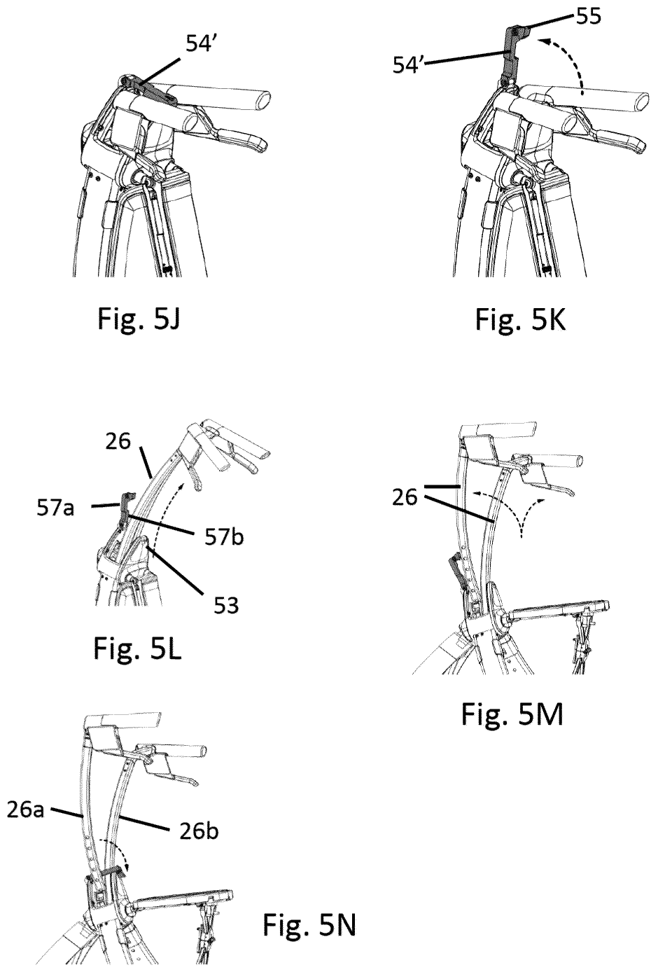

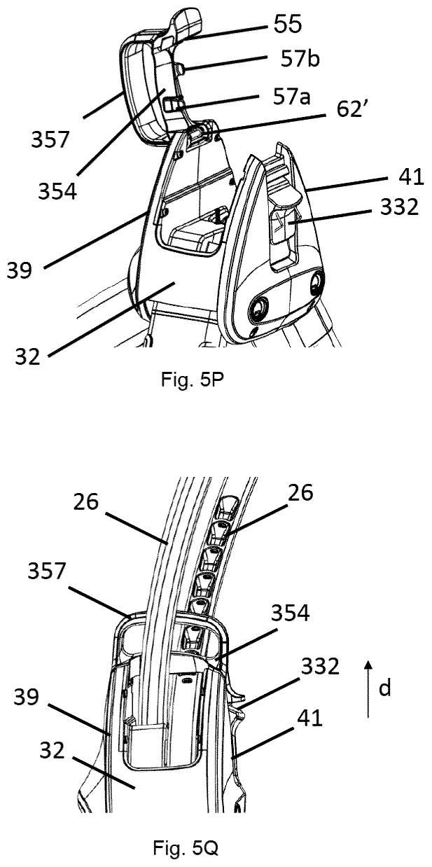

FIGS. 5A-5G show various detailed views of a first example of a hub 32 of rollator 300, 301, the hub 32 comprising a hub front portion 39 and a hub rear portion 41 interconnected to each other and forming comprises top openings 42, (which could be constituted by a single opening or slot), and bottom openings 44 (which also can be formed by a single opening/slot), formed between front and rear hub portions 39, 41. Top openings 42 are dimensioned to allow arms 26 to move toward and away from each other; and bottom openings 44 are dimensioned to allow rear legs 20a, 20b, to move toward and away from each other.

In the present example, the hub 32 also comprises arm-leg assembly fastener pivot pins 46 (FIG. 5A), defining a central longitudinal pivot axis 46a extending through their length. The rear leg proximal ends 34a and 34b are pivotably attached to the hub by the fastener pivot pins 46, whereby the arm-leg assemblies 226 can pivot (scissor) between a proximal, closed position and an distal, open/deployed position. Arm-leg assemblies 226 can thus be pivoted about the central longitudinal pivot axis 46a in a scissor-like manner when arm handles 28 are spread apart and brought toward each other. When in a deployed state (distal position, FIGS. 1A-1C), assemblies 226, specifically arms 26, cross each other to form an X-shape in an assembly crossing area 40 of hub 32 located between the front and rear hub portions 39, 41.

In general, the hub can comprise spread preventing means for preventing the arm-leg assemblies from spreading too much, and in further cases, for securing the arms to the hub in their opened, distal position. In some cases, the spread preventing means can be adjusted so as to change the maximal spread of the arm-leg assemblies for the comfort of a user. In other cases, the spread preventing means can be fixedly integrated with the hub in a manner that provides the most stability for the movement platform when in their opened, distal position. This feature can make it convenient for the user to spread the arms to the full extent to an angle predetermined for typically comfortable spread thereof.

In the present example, hub 32 comprises two arm-spread limiting surfaces 48 (FIG. 5B) located within the hub. Arm-spread limiting surfaces 48 are sloped at an angle for abutting the arms of the arm-leg assemblies in their distal position, to thereby control the extent to which they may spread. In this example, the arm-spread limiting surfaces 48 are configured to abut the arms when in their distal positions. Thus, when a user spreads arms 26 to their full extent, the corresponding proximal portion 38 of each of the arms 26 is configured to contact its respective arm-spread limiting surface 48 of the hub 32, thereby setting the arm spread in the distal position.

Each arm-leg assembly can further comprise an arm height-fixing mechanism operable to reversibly limit the extent to which each arm can be extended from its corresponding leg. The arm height-fixing mechanism can limit each of the arms to a plurality of heights, so as to form a plurality of extended states. In particular, the arm height-fixing mechanism can be located adjacent or at the proximal end of the legs.

FIG. 4 shows an exemplary arm height-fixing mechanism 51 comprising a plurality of arm-limiting, pin-receiving apertures 50, formed in each of arms 26 and spaced along the length of the arms; each of the pin-receiving apertures 50 is configured to receive therein a height-fixing pin 52, which protrude laterally outwards from the arm-spread limiting surface 48 of the hub 32 (as shown in FIG. 5A) Alternatively, each of the arms may have an array of height-setting arm pins and hub 32 can have a height-setting recess or recesses for receiving at least one of said pins.

The hub can further comprise an arm securing mechanism configured to secure the arms to the hub in their distal and or proximal positions, so as to secure the arms from erroneously changing their position. In some cases, the arm securing mechanism can also be configured to reduce or eliminate any possible shaking and/or rattling of the arms while in either one of their positions. The arm securing mechanism can comprise a single element for both arm-leg assemblies or one for each arm-leg assembly.

FIGS. 5C-5I show an exemplary arm securing mechanism comprising two arms securing elements 54, one for each arm-leg assembly, pivotally connected to the hub 32 and having arm-interfacing faces 56 configured to press on respective arms 26 to abut them against the corresponding arm-spread limiting surfaces 48. Specifically, hub 32 is configured so that hub front and rear portions 39, 41 have front and rear arms securing elements 54 that can be opened outwardly (FIG. 5F), for example via respective pivot members 62 and closed inwardly (FIG. 5G) via those pivot members, and reversibly held in the closed position by respective snap fit members 64.

FIGS. 5J-5N show another exemplary arm securing mechanism comprising a single arms securing element 54′ pivotally connected to the hub 32 and having two opposite arm-interfacing faces 57a and 57b along its length, one in front of the other, configured to press on both of the respective arms 26, which are positioned one in front of the other, so as secure them in either one of their positions by abutting each arm against its corresponding arm-spread limiting surface 48.

Specifically, the arms securing element 54′ is pivotally connected at a first end thereof to hub 32 at its hub front portion 39 via respective pivot member 62′ and the hub rear portion 41 has a notch 53 configured to receive a locking protrusion 55 of the arms securing element 54′, which protrude from the other end thereof, therein.

More generally, when the hub comprises an arm securing mechanism constituted by at least one arm securing element, the arm securing mechanism can be movable between an open state, in which the first and second arm-leg assemblies are allowed to pivot between the distal positions and the proximal positions thereof, and a closed state, in which the first and second arm-leg assemblies are prevented from pivoting between the distal positions and the proximal positions thereof. In particular, the arm securing element can have a proximal end connected to the hub and a distal end comprising a locking component. The hub can further include a locking component receiving portion configured to lockingly engage the locking component when the arm-securing element is in its closed state.

In some examples when the hub comprises an arm securing mechanism constituted by at least one arm securing element, as described above, the device can further comprise a securing element handle that protrudes at least from the at least one arm securing element in a direction away from the hub, at least in the closed state of the arm securing element. When the arms securing element is in the closed state, the handle can be gripped by a user to lift and/or push the device, which may be necessary for various reasons, such as transporting or repositioning the device. The handle can offer a comfortable solution for moving the device. Any appropriate locking component and locking component receiving portion can be provided that ensures the locking engagement remains secure during movement or when lifting forces are applied to the handle. In some cases, the locking component receiving portion can be a spring-loaded latch or clip mechanism that snaps securely onto a correspondingly shaped locking component. In other cases, the locking mechanism and locking component receiving portion can be constituted by the previously described locking protrusion and notch.

In some cases, the locking component receiving portion can comprise a release mechanism operatable by a user to release the locking engagement of the locking component and a part of the locking component receiving portion. For example, the release mechanism can include a spring-loaded piece biased in a locking direction, such that when the locking component is engaged in part of the locking component receiving portion, the mechanism urges the elements to remain locked. A user can press down on the spring-loaded piece to overcome the bias and disengage the locking component from the part of the locking component receiving portion, allowing the arm securing mechanism to move to its open state. In another example, the mechanism can include a pivotable latch that locks into place when the locking component is engaged and can be manually rotated by a user to release the locking engagement, enabling the locking component to disengage from the locking component receiving portion.

FIGS. 5P and 5Q illustrate an example of a securing element handle 357 protruding from an arm securing element 354, in the open and closed states of the arm securing element, respectively. The securing element handle 357 can be provided directly on the arms securing element 54′ described with respect to FIGS. 5J to 5N. In the present example, the hub comprises the same features as the previously described hub 32, with the addition of a release mechanism designated 332, and is thus referred to with the same reference numerals. Similarly, in the present example the arms securing element 354 comprises features corresponding to the arms securing element 54′ and these features are thus referred to with the same reference numerals. Namely, arm securing element 354 is pivotally connected to a hub front portion 39 of the hub 32 at a securing element proximal end 332 via respective pivot member 62′. A hub rear portion 41 has a locking component receiving portion comprising notch 53 configured to receive a locking component constituted by locking protrusion 55. The arms securing element 354 has two opposite arm-interfacing faces 57a and 57b spaced along its length, one in front of the other, configured to press on both of the respective arms 26 (not shown in FIG. 5P). The locking component receiving portion further comprises release mechanism 332 constituted by a spring-loaded piece 332 biased in a locking direction d.

The hub 32 comprises a hub front portion 39 and hub rear portion 41 are spaced from each other by a top opening 42 of the hub 32. As seen in FIG. 5Q, when the arms securing element is in its closed state, the hub front and rear portions 39, 41 are connected by the arms securing element 354 at the top opening 42. The handle 357 protrudes from the arm securing element in the direction away from the top opening 42.

In some cases, the arms can be limited to extend only up to a portion of their maximal height, in order to enable suitable fit for a plurality of users in different heights. For this purpose, the moveable platform can be configured with a height limiting mechanism, which can be changeably operated to limit the height to which the arms can extend from the legs.

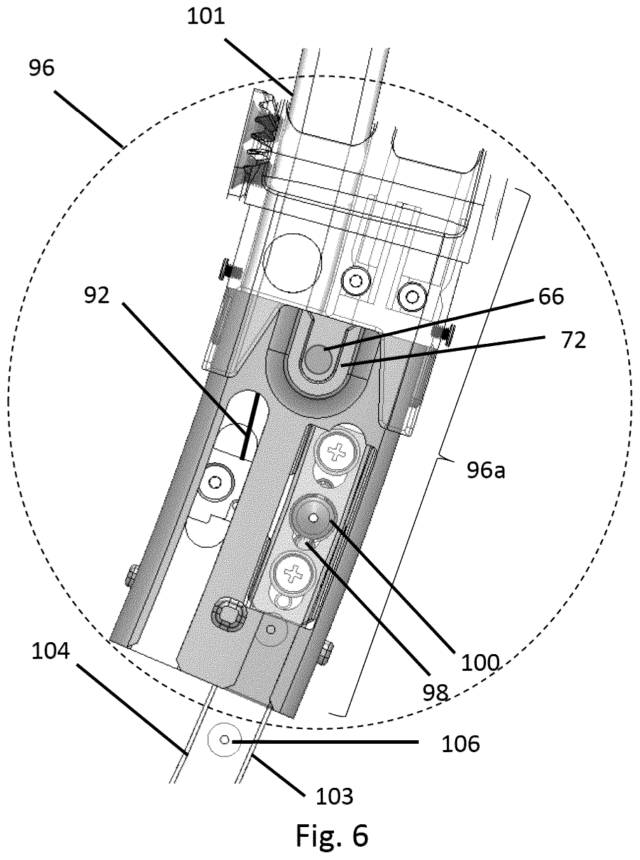

FIG. 6, with reference also to FIG. 4, shows an exemplary height limiting mechanism comprising a height limiting pin 66 and a height limiting pin holder 68 associated with each rear leg 20a,20b. Height limiting pin 66, which may be tethered to holder 68, is dimensioned to be received in any one of a plurality of height-limiting apertures 70 disposed in an internal surface of rear legs 20a, 20b and to stop the upward extension of arms 26 via a height-limiting stopper 72 (illustrated as having a U-shape in FIG. 6) at the proximal portion 38a, 38b of the arms. As such, to set the extent to which arms 26 can be extracted, the user can insert the height limiting pin 66 of the holder 68 into one of the plurality of corresponding height-limiting apertures 70. As a result, arms 26 will be stopped at the desired height from then onward, with no need for any further manual height setting. Because height-limiting stopper 72 is open (not blocking) at its upper side, as illustrated, arms 26 can be lowered for insertion/folding.

In some embodiments of the presently disclosed subject matter, the movement platform can comprise a front leg deployment and folding mechanism. Such mechanism can be accommodated within its hub and be operable to move the front leg(s) between a front leg distal position in which their distal end(s) is/are disposed at a maximal distance from distal ends of rear legs when the rear legs are in their distal position, and a front leg proximal position, in which the distal end(s) of the front legs is/are disposed close to the distal ends of the rear legs, when the rear legs are in their proximal position.

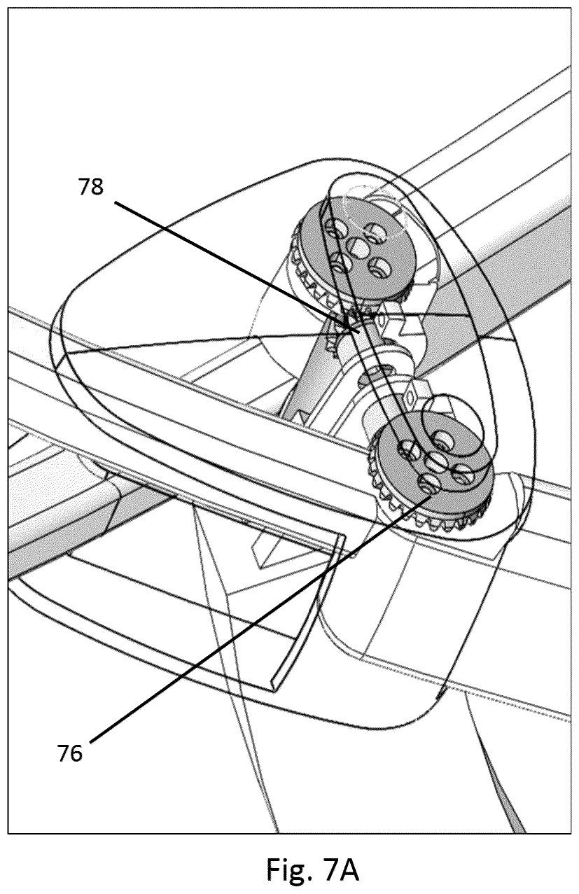

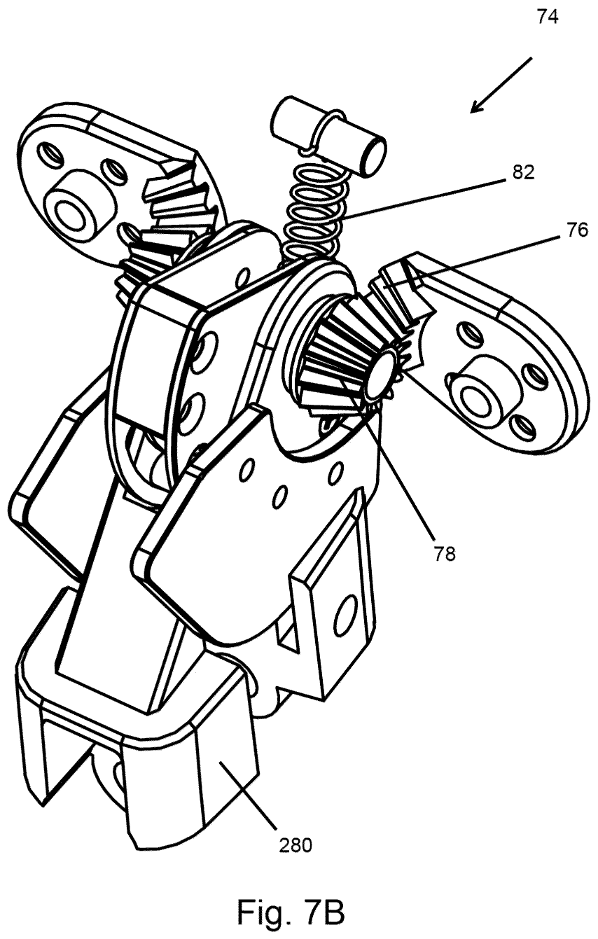

FIGS. 7A-7B, as well as FIGS. 5D and 5E, show an exemplary front leg deployment and folding mechanism 74 of rollator 300 configured to pivotally move the front leg 20c between its distal, frontward position which is associated with the deployed state of the rollator (FIGS. 1A-1C) and its proximal, rearward position, which is associated with the folded state of the rollator (FIGS. 2A-2C), in which the front leg is located near, optionally between the rear legs—and vice versa. Front leg deployment and folding mechanism 74 includes a pair of proximal end rear leg gears 76, each of the gears fixed and operably connected at respective proximal ends 34a, 34b of each rear leg 20a, 20b, and in some cases, about fastener pivot pins 46.

Front leg deployment and folding mechanism 74 also includes a front leg transmission element 280 having a pair of front leg gears 78 at a proximal end thereof and connected to the front leg at a distal end thereof. The front leg gears 78 are disposed perpendicularly to proximal end rear leg gears 76 and mesh therewith such that when the rear leg gears 76 rotate during folding of the rollator, front leg gears 78 rotates respectively so as to move front leg 20c between its distal position and its proximal position near or between rear legs 20a, 20b.

In the present example, the rear legs 20a, 20b are configured to spread to form an angle therebetween of about sixty degrees therebetween, where each rear leg gear 76 rotates about thirty degrees or one twelfth of a turn, when handles 28 are moved from their fully spread position to their adjacent position, or vice versa. During deployment, rear leg gears 76 rotate so that their gear teeth that are meshing with those of gears 76 move causing the corresponding teeth of gears 78 to move respectively, thus moving front leg 20c forward, away from rear legs 20a, 20b. Closing handles 28 toward each other produces the opposite gear movement. Thus, spreading handles 28 automatically deploy front leg 20c (FIGS. 1A-1C); and moving the handles toward each other automatically folds the front leg, (FIGS. 2A-2C). The gears can be sized differently so as to result with different angle opening thereof. for example, in the present example gears 76 and 78 are sized in approximately 3:1 diameter ratio, such that the front leg 20c would open to greater extent than rear legs 20a, 20b.

With reference to FIGS. 5D and 5E, the front leg deployment and folding mechanism 74 may include a biasing assembly 80 to secure front leg 20c in place, whether in the folded or deployed state and/or to apply urging force towards either one of its position upon movement thereof so as to prevent the front leg from unintended change in its position. In the present example, the biasing assembly 80 is constituted by a spring, which center-passes the pivoting route of the leg transmission element 280, and respectively, of front leg 20c.

The rollator according to the presently disclosed subject matter can comprise a movement transmission mechanism which is configured to transmit actuation performed about the arm to an actuation performed in the leg, when the arm and leg are configured to change their place with respect to each other, such as in a telescopic manner. For example, the movement transmission mechanism can transmit an actuation performed by a user on a brake actuating lever associated with at least one of the arms, or specifically with the handle thereof, to an actuation of a brake associated with at least one of the legs. Thus, the movement transmission mechanism can be utilized to form a wheel braking mechanism.

At least a part of the movement transmission mechanism can be moveable together with the corresponding arm relative to the corresponding rear legs, between an extended and a retracted state of the mechanism corresponding to the respective extended and retracted states of the arm to allow braking at any arm height/extension. At least a majority of movement transmission mechanism is disposed internally to the arm-leg assemblies, thereby obviating the typical loose external brake cables of known rollators as well as helping provide for a compact collapsed position of the rollator.

The movement transmission mechanism can comprise an arm associated portion, a leg associated portion, and an interconnecting portion which interconnects the arm and leg portions upon actuation of the arm portion so as to operate on the leg associated portion to thereby affect the transmission of the actuation therethrough.

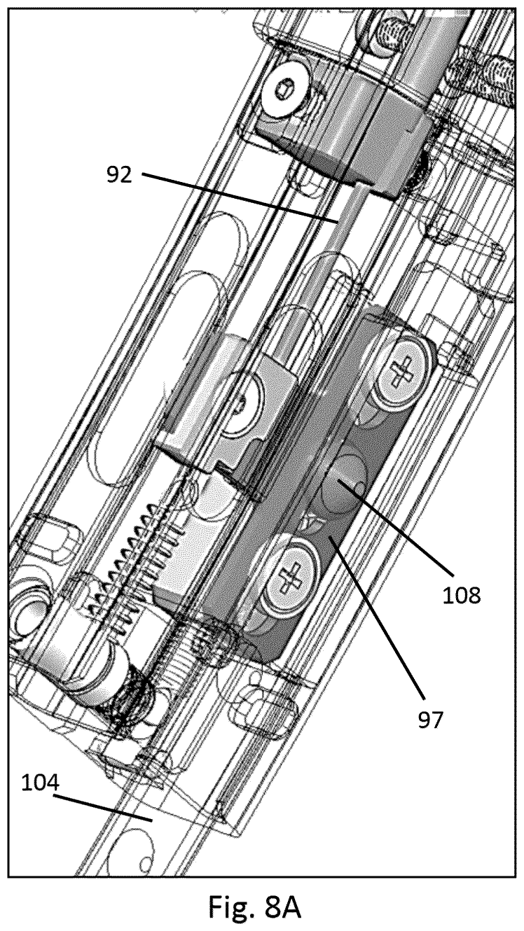

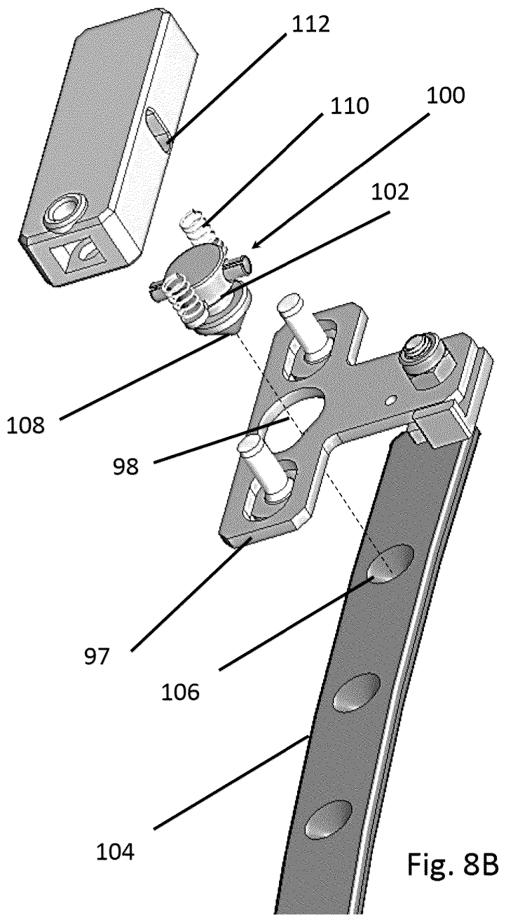

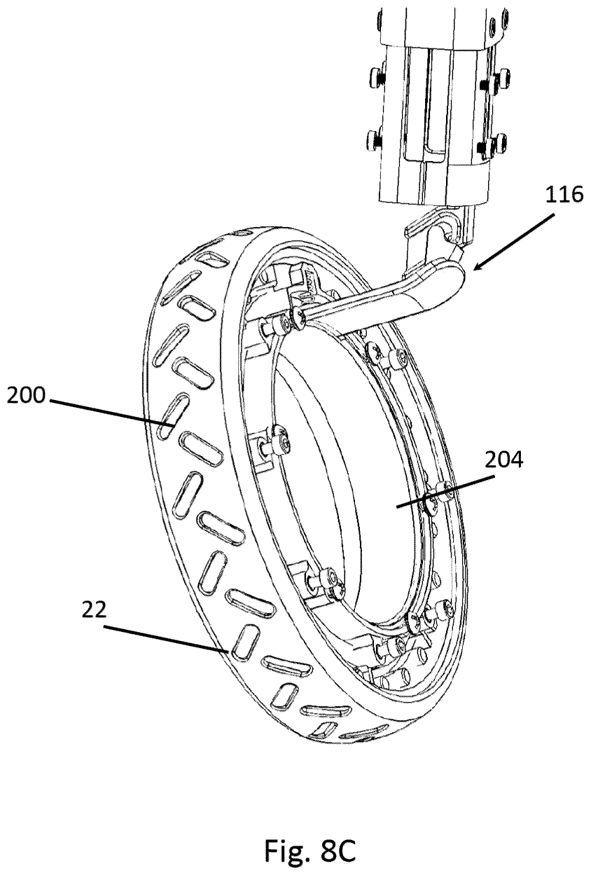

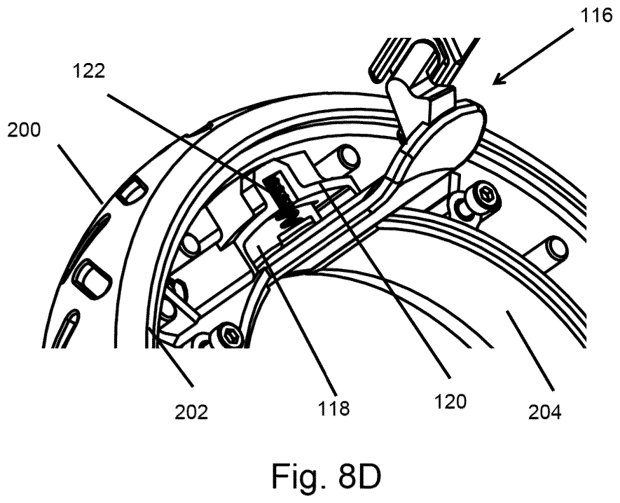

FIGS. 8A-8D show one example of a movement transmission mechanism 90 that is used in the rollator 300, and specifically, in the arm-leg assemblies 22 thereof. The movement transmission mechanism 90 comprising a brake cable 92, attached at one end thereof to a brake actuating element 94, constituted by the brake actuating lever 94, the other end being attached to an interconnecting structure, exemplified by a T-shaped intermediate brake element 97, which is attached to proximal portion 38a, 38b of at least one of arms 26 and has a tear-drop or cam-shaped opening 98 therein. A mushroom-shaped member 100 of intermediate brake element 97 is received within cam-shaped opening 98, in particular a stem 102 of the mushroom-shaped member. Movement transmission mechanism 90 further comprises an elongated flat brake-movement strip 104, which is curved to correspond to rear legs 20a,20b and is housed therein. Strip 104 comprises a plurality of cone-shaped recesses 106 for receiving a correspondingly cone-shaped top 108 of mushroom-shaped member 100, which is reversibly urged into the recesses by a spring 110, which may be housed in a mushroom-member housing 112 of (or attached to) T-shaped intermediate brake element 97. Recesses 106 are spaced apart in correspondence to the spacing of height-limiting apertures 70 in rear legs 20a, 20b. The corresponding conical shape of top 108 of mushroom-shaped member 100 and cone-shaped recesses 106 allow for the cone-shaped top 108 to readily slide in and out of the recesses when arms 26 are raised and lowered, aided by one or more suitably configured springs 110. The lower end of brake-movement strip 104 is connected to a brake-pad assembly 116 comprising a brake pad 118, configured to interface with a wheel drum 120 of wheel 22. Brake-pad assembly 116 may comprise a biasing component 122 to urge and distance brake pad 118 away from wheel drum 120, to prevent unwanted friction/braking.

Note, the cam-shaped opening 98 is advantageous to allow easy assembly (insertion) of mushroom-shaped member 100 into the larger opening portion thereof and the narrower portion of the cam-shaped opening is smaller than the cone-shaped top 108 to thereby force the top into a nearby recess 106 of brake-movement strip 104 (not allow mushroom-shaped member 100 to slide along strip 104), during braking.

With such a design, when brake actuating lever 94 is squeezed by the user, brake cable 92 is raised (e.g., 10 mm) thereby raising T-shaped intermediate brake element 97, causing cam-shaped opening 98 to capture stem 102 of mushroom-shaped member 100 therein. Capturing stem 102, forces the cone-shaped top 108 of mushroom-shaped member 100 to enter an adjacent recess 106 (a distance of less than 10 mm, e.g., say 6 mm) during its initial upward movement. The remaining upward movement by mushroom-shaped member 100 causes strip 104 to be pulled upward (e.g., the remaining 4 mm) thereby forcing brake pad 118 to press on wheel drum 120 of wheel 22 to prevent rolling. Thus, movement transmission mechanism 90 can provide braking at any arm height, without any external cable.

The movement transmission mechanism can also alternatively be arranged in a continuous manner so as to interconnect the actuatable element associated with the arms to the actuating element associated with the legs. In this case, the movement transmission mechanism can comprise an arm associated portion, a leg associated portion, and an interconnecting portion which interconnects the arm and leg portions upon actuation of the arm portion so as to operate on the leg associated portion to thereby affect the transmission of the actuation therethrough.

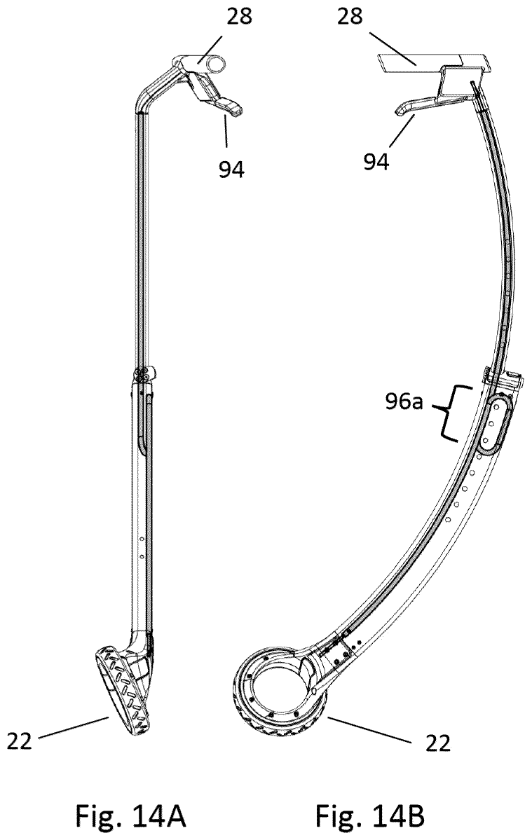

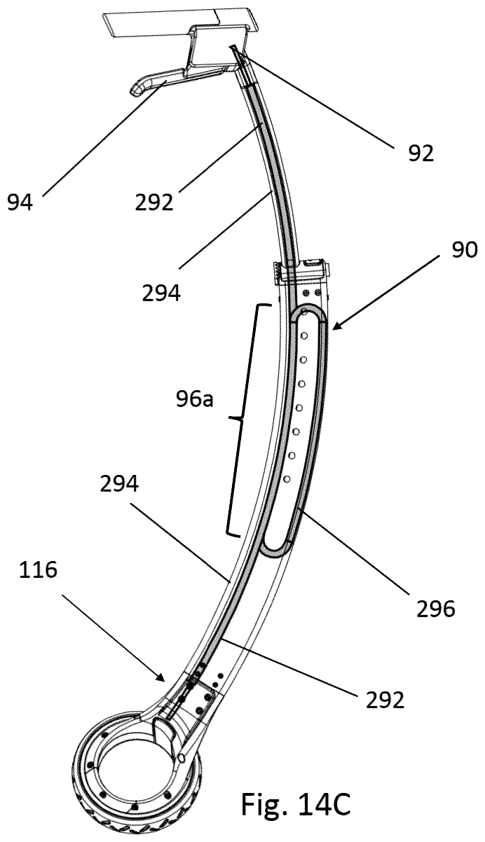

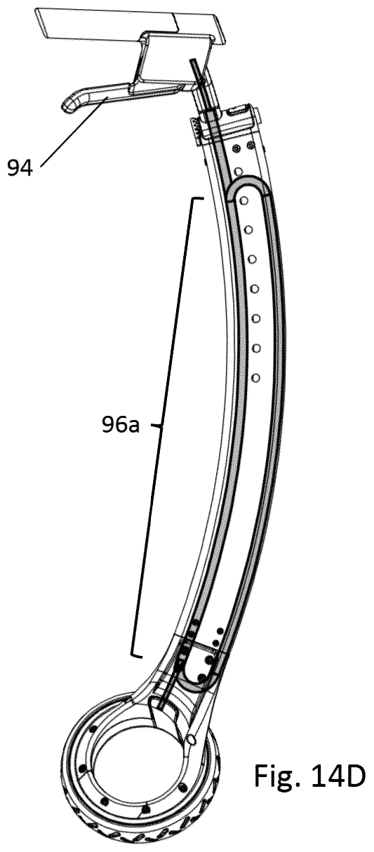

FIGS. 14A-14D show an alternative example of the movement transmission mechanism 90 that can be used in the platform (in particular in arm-leg assemblies 226), exemplified in rollator 300, 301, comprising brake cable 92, attached at one end thereof to brake actuating lever 94, the other end being attached to brake-pad assembly 116. Brake cable 92, in this example, comprises an inner brake cable 292 and an outer flexible brake cable sleeve 294, which are configured so as to form a loop 296, which constitutes the overlapping area 96a, located within a hollow portion of rear legs 20a, 20b, and pressing up against the inner walls of the hollow portion of the rear legs.

As seen in FIGS. 14A-14B, when arms 26 are raised, loop 296 is relatively small; and as the arms are lowered (FIGS. 14C and 14D) the loop gets bigger, taking up “slack” in the brake cable 92 and its sleeve 294. FIG. 14C also illustrates the loop 296 formed where arm 26 and leg 20 overlap, when the arm is not fully extended.

Thus, when brake actuating lever 94 is squeezed, brake cable 92 is raised, thereby forcing brake pad 118 to press on wheel drum 120 of wheel 22 to prevent rolling, as noted. Thus, this example of movement transmission mechanism 90 can also provide braking at any arm height, without any external cable.

A rollator according to the presently disclosed subject matter can further be provided with a seat detachably attachable or permanently fixed thereto. In both cases, the seat can be pivotable upward and downward via a seat lowering-raising mechanism. For example, the seat can be attached to the hub and to the rear legs of the rollator at least three respective seat connection areas.

In some embodiments of the presently disclosed subject matter, the rollator may comprise a seat, and a seat lowering and raising mechanism operable to pivot the seat between an operational raised orientation for sitting thereon and a non-operational downward orientation. The seat may be pivotally connected, either directly or operably to the hub and articulably connected, either directly or indirectly to the rear legs. It is emphasized that the seat can be articulated to the rear legs in a manner enabling them to spread apart while still providing sufficient support for the seat to enable a user to be seated thereon.

In particular, the seat can be pivotally connected directly to the hub by a pivot axle, and can be connected to the rear legs by joints positioned on the rear surface thereof, enabling the seat to be connected to the rear legs, while the rear legs travels both laterally away form each other and rearwards to the hub.

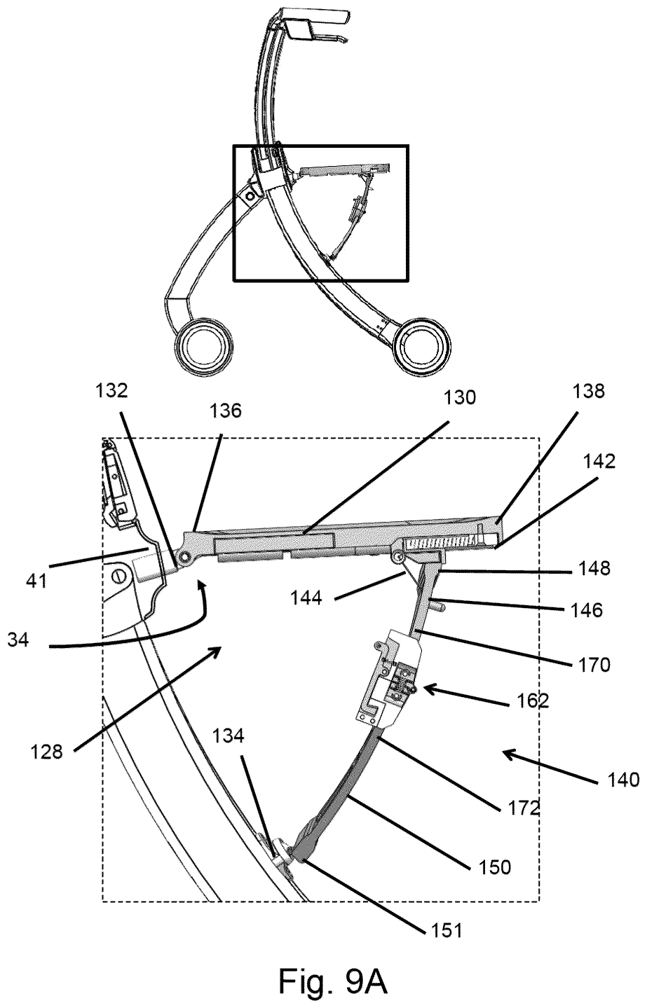

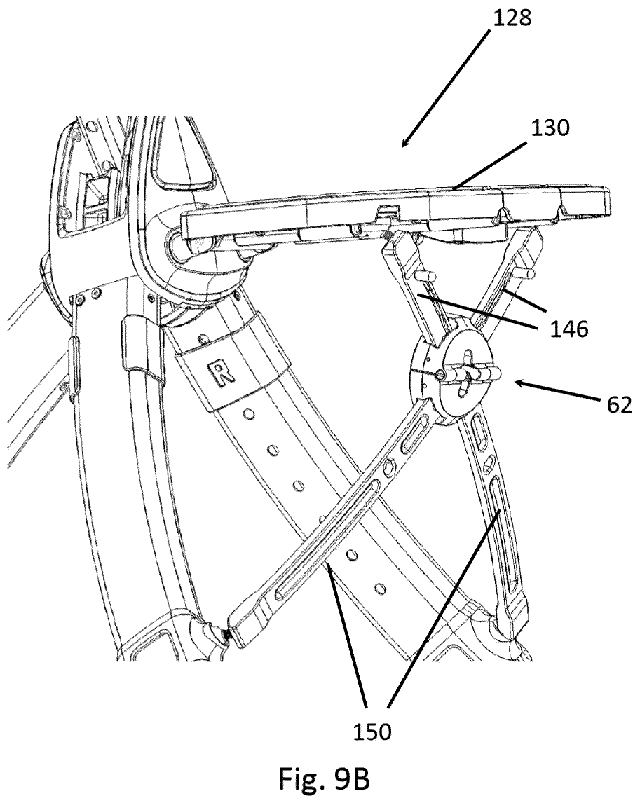

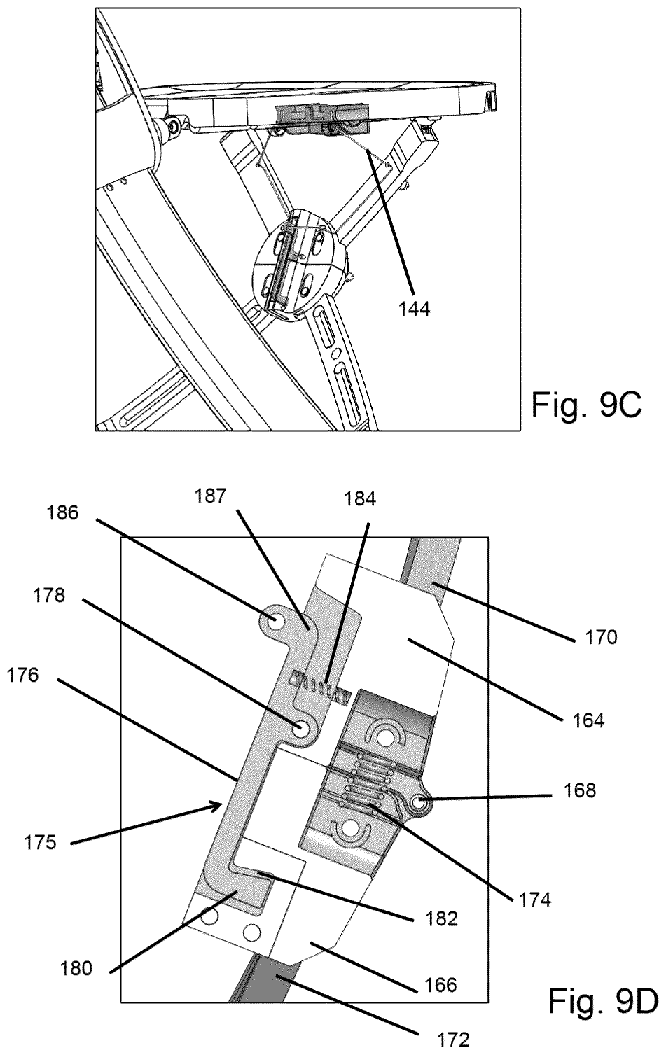

FIGS. 9A-9E show an exemplary seat assembly 128 including a seat 130, which can be fixedly or detachably connected to rollator 300, 301 at a proximal connection area 34 thereof by means of a pivotable proximal connector 132 connected to hub 32 at hub rear portion 41 and at two distal ball-joint connection points 134, respectively connected to rear legs 20a, 20b. Seat 130 has a proximal (rear) seat edge 136 adjacent hub 32 and a distal (front) seat edge 138 that moves in an arced path when the seat is pivoted upward and downward.

The seat lowering-raising mechanism 140 comprising a seat adjustment actuator 142; actuator wires 144; a pair of upper seat adjustment members 146, whose upper ends 148 operably attach to the bottom of seat 130; and a pair of lower seat adjustment members 150 whose lower ends 151 operably attach to rear legs 20a, 20b. Upper and lower seat adjustment members 146 and 150 may be curved in a convex orientation when seat 130 is deployed, in order to provide improved stability and/or other reasons that may become apparent.

The seat lowering-raising mechanism 140 also comprises a foldable support element 162 being constituted in this example by a central folding disk having an upper disk portion 164 and a lower disk portion 166, hingedly joined at the side of the folding disk facing away from hub 32 at a hinge 168 when seat 130 is deployed and toward the hub when the seat is lowered. Lower ends 170 of upper seat adjustment members 146 operably attach to central folding disk 162 as do upper ends 172 of lower seat adjustment members 150.

Central folding disk 162 may comprise a center-pass spring 174 attached at one end to upper disk portion 164 and at its other end to lower disk portion 166. Center-pass spring 174 is configured to bias folding disk 162 in a flat (non-folded) position (e.g., FIG. 9A) in which seat 130 is deployed, once the folding disk has passed a particular partially opened position; and to bias the folding disk closed when the folding disk has passed a particular closed (folded) position, in which the seat is folded down (FIG. 9E).

To provide increased stability to central folding disk 162, and prevent inadvertent folding thereof, for example by kicking the disk into a folding position by the user's heel while sitting, the central folding disk may include locking arrangement 175 including a disk-locking lever 176 spanning between upper disk portion 164 and lower disk portion 166. Disk-locking lever 176 may be pivotably hinged at a pivot point 178 of upper disk portion 164 and have a hook 180 receivable in a notch 182 of lower disk portion 166.

Disk-locking lever 176 may have a lever spring 184 biased to urge hook 180 into notch 182. Additionally, or alternatively, hook 180 may be angled (hooked) to provide a snap fit when in notch 182, thereby requiring a threshold force to pivot disk-locking lever 176 about pivot point 178. To release disk-locking lever 176, thereby allowing folding disk to fold about hinge 168, actuator wires 144 are attached to a wire-connection point 186 of the disk-locking lever 176.

To deploy seat 130 to a position to support a user, one can simply pull upward on proximal seat edge 136 of the seat until the seat is horizontal, and seat lowering-raising mechanism 140 will automatically place disk-locking lever 176 in its locking position (FIGS. 9A-9D).

To fold (lower) seat 130, a user can pull seat adjustment actuator 142 outward thereby pulling on actuator wires 144, which are attached at one end to the seat adjustment actuator and at their other end to wire-connection point 186. This pulls wire-connection point 186 of disk-locking lever 176 towards central folding disk 162 (in particular upper disk portion 164) and thus pivots the disk-locking lever. The pivoting of disk-locking lever 176 removes hook 180 from notch 182. This pivoting also causes an upper portion 187 of disk-locking lever 176 to push on upper disk portion 164, causing central folding disk 162 to fold, about hinge 168, to a folded position as illustrated in FIG. 9E.

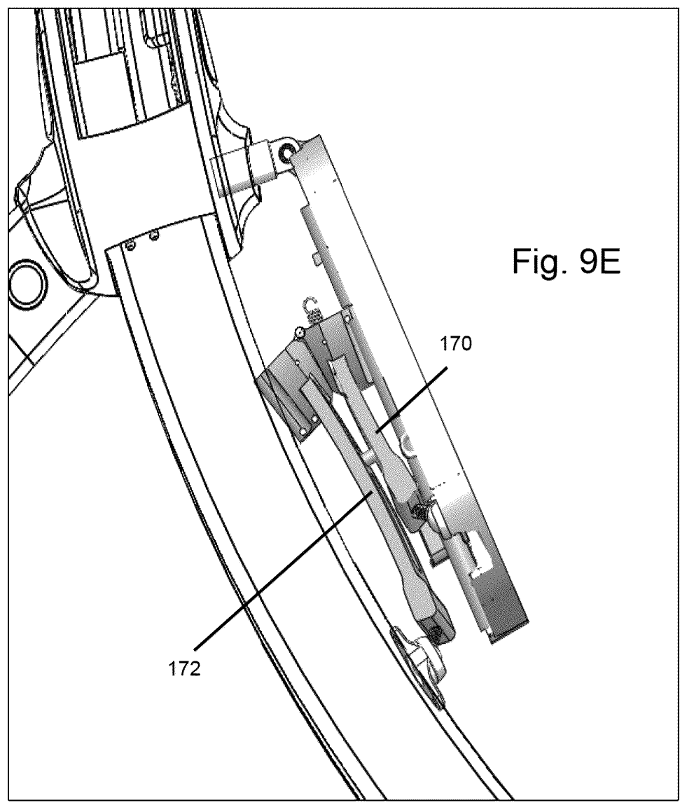

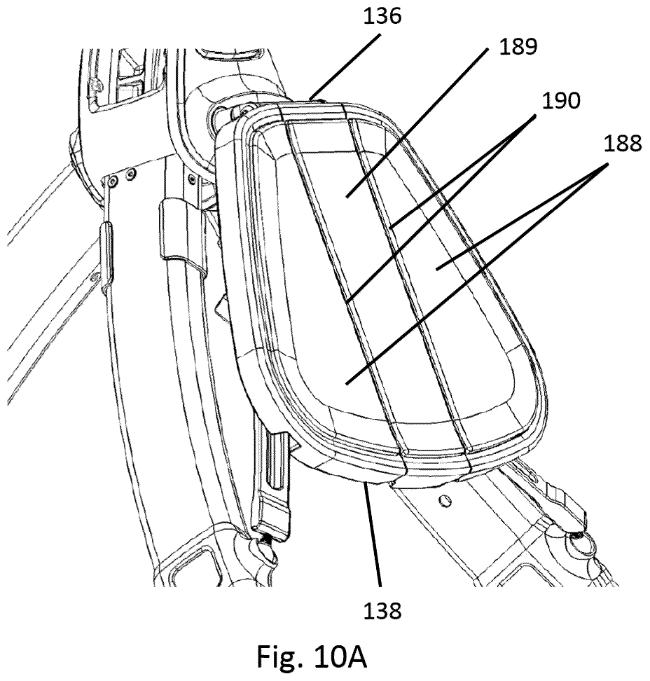

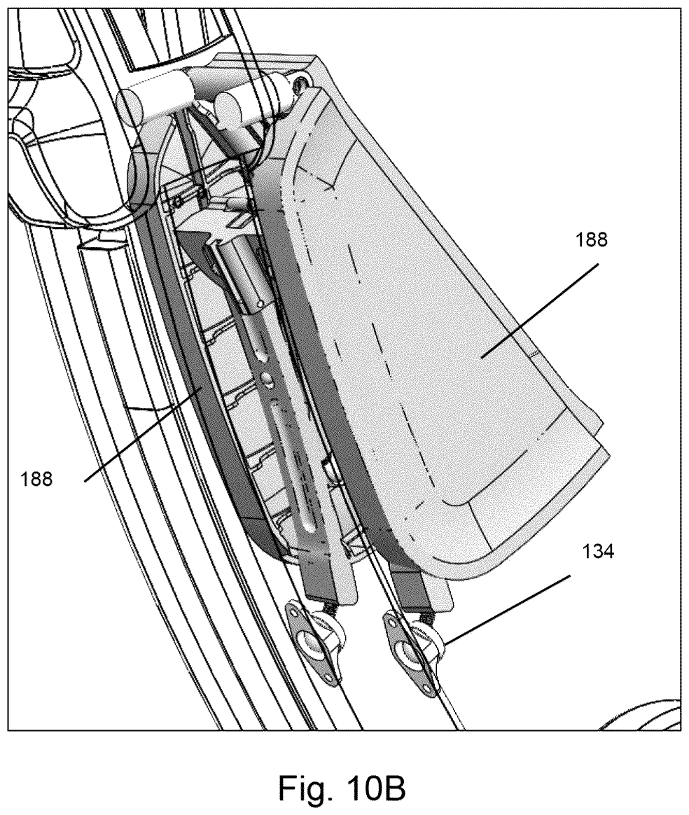

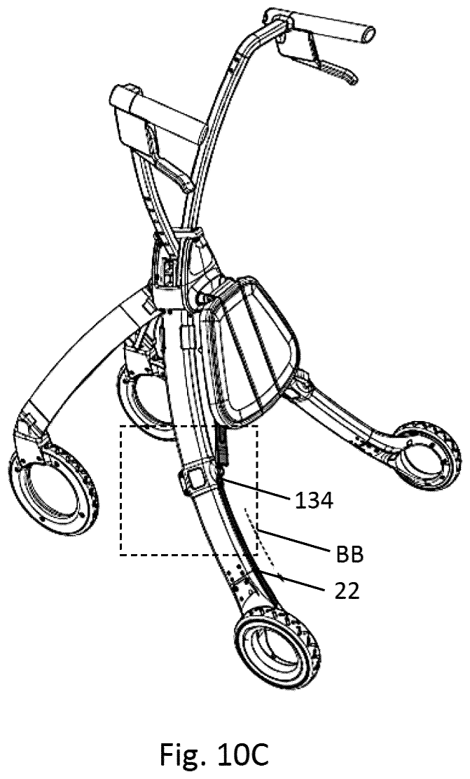

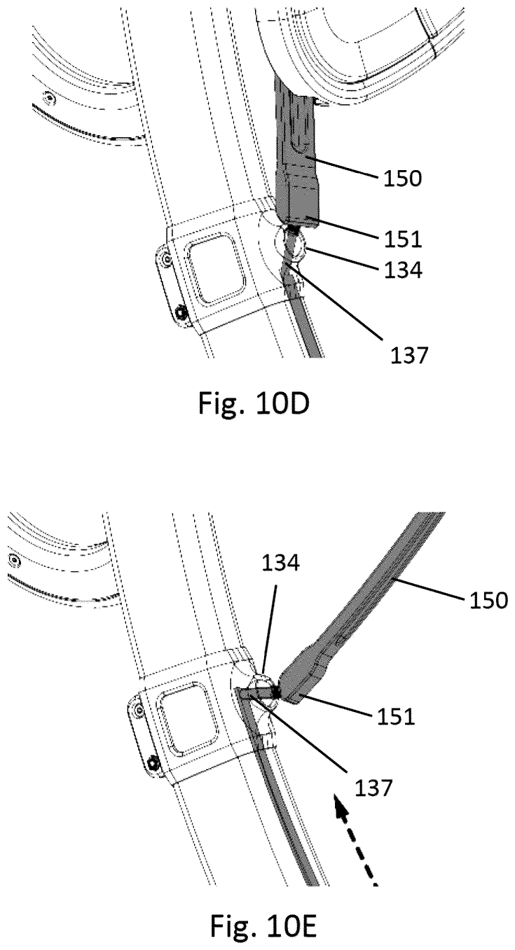

FIGS. 10A-10B illustrate an additional exemplary seat folding feature, in which seat 130 of the rollator according to the presently disclosed subject matter can have. This feature relates to a structure of seat 130 having a central seat portion 189 and a pair of right and left side foldable wings 188 being inwardly foldable along respective side wing pivot axes 190 (via hinges) extending from proximal seat edge 136 to distal seat edge 138. Upper seat adjustment members 146 may be connected to the bottom of respective wings 188 whereby, when seat 130 is folded downward, as described above, the wings fold inward, thereby reducing the profile of the folded rollator for easier storage. When seat folding disk 162 is folding, and seat 130 is moving downward, two wing pins (not visible) at respective upper seat adjustment members 146 enter respective lower seat-folding arm apertures (not visible) causing seat wings 188 to be folded about their side wing pivot axes 190.

In reverse, when the seat 130 is raised, the upper seat adjustment members 146 press upward on wings 188 to place the seat is a generally flat configuration suitably for sitting thereon. Alternatively, wings 188 may constitute the entire seat 130, whereby the seat would be in a V-shape along a lone axis extending along the middle of the seat from proximal seat edge 136 to distal seat edge 138.

It is emphasized that the term “front leg” can include, in some cases, two or more front legs operably connected to each other directly, via the hub, or via an additional element. In other cases, the moveable platform can comprise several front legs, where each of which can be considered as an single leg and be associated with its own front leg deployment and folding mechanism.

When the front leg is two or more front legs, the two or more front legs can be connected to each other in their proximal end such that only a single proximal end can be connected to the hub (for example, leg transmission element 280). In some cases, the cross section of the distal portion of the front legs can be wider than the gap between the rear legs in their proximal position, where the front legs are positioned rearwards thereto, such that the rear legs are required to be separated from each for enabling the two front legs to move towards their distal position. In other cases, the two front legs can be configured with a narrow cross section when in their proximal position, for example, by being adjacent to each other or having their wheels maintained in a vertical stance such that they can move concurrent with the rear wheels. The two front legs can be configured to spread from each other upon movement thereof towards the distal position, possibly only after passing the rear legs.

In some cases, the movement transmission mechanism further comprises a seat state indication element, which can operably connect the brake-pad assembly to the seat lowering-raising mechanism, while providing indication to or causing actuation in accordance with the state of the seat. Specifically, the seat state indication element can be configured to actuate the brake-pad assembly when the seat is in its supporting state. The actuation of the brake-pad assembly can occur either directly via the leg associated portion or via a parallel element to the leg associated portion that is also connected to the brake pad.

In the present example, best shown in FIGS. 10C to 10E, the distal ball-joint connection points 134 further comprises a seat state indication element 137. The seat state indication element 137 operably connects the brake-pad assembly 116 to the seat lowering-raising mechanism 140. Specifically, the seat state indication element 137 is connected at one end thereof to the lower end 151 of the corresponding lower seat adjustment member 150 and at a second end thereof to the leg associated portion (for example, strip 104) of the movement transmission mechanism 90.

In operation of the present example, when the seat is raised, the second end of the state indication element 137 pivot upwards and thereby lifting the leg associated portion so as to actuate the brake pedal. However, in other example the state indication element 137 can operate differently to actuate the brake in response to rising of the seat towards its deployed state, and to release the brake in response to lowering of the seat towards its folded/retracted state.

FIGS. 11A-11C, 12A-12C, and 13A-13C show rollator 301, with two front legs 20c, 20d. Rollator 301 comprises a front leg deployment and folding mechanism, which is generally similar to the front leg deployment and folding mechanism of rollator 300. However, due to the larger space taken by the two front legs 20c, 20d (and/or their two respective front wheels) with respect to only one front leg (with its one wheel), in this example, upon initially transitioning between the folded position and the deployed position, those two front legs 20c, 20d and/or their wheels are too large to pass between the rear legs 20a,20b. For this reason, rollator 301 comprises a front leg deployment delay mechanism to delay the forward movement (deployment) of the two front legs until the rear legs 20a,20b open (i.e., the distal ends thereof open) enough so that the front legs and/or their wheels can pass therethrough.

Reverting to FIGS. 5D and 5E, the rollator 300, 301 comprises a front leg deployment delay mechanism 192 comprising a front leg deployment delay member 194 disposed in hub 32 and operably attached to front leg gears 78 so that rotation of the front leg gears rotates the delay member in the same direction. Delay member 194 comprises an arced delay-slot 196 configured to receive a delay-pin 198 connected to proximal end 34c of front legs 20c, 20d.

Delay mechanism 192 is configured so that the spreading of rear legs 20a, 20b for deployment causes rear leg gears 76 to rotate thereby rotating front leg gears 78. Delay member 194 is similarly rotated, whereby arced delay-slot 196 moves in an arced manner corresponding to its curvature. The configuration of delay mechanism 192 is such that a delay-slot end 200 of delay-slot 196 will impact delay-pin 198, to initiate forward movement of front legs 20c,20d, only after rear legs 20a,20b have opened sufficiently to allow wheels 22c, 22d to pass between the rear legs.

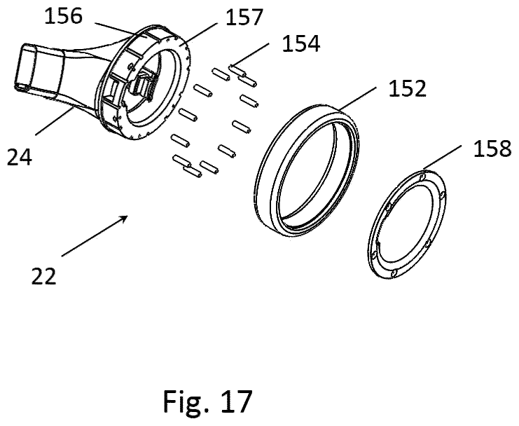

Reverting to FIG. 8D there is shown an exemplary design of wheels 22, which can be used in a rollator according to the presently disclosed subject matter. Each of the wheels 22 has an annular configuration and includes an outer annular wheel member 202 that interfaces with the tire; an inner annular wheel member 204 configured to fit within the outer annular wheel member; and a plurality of cylindrical roller bearings 206 disposed between the two annular wheel members 202 and 204. Such design allows wheels 22 to be hubless (FIG. 17), and consequently well suits internal movement transmission mechanism 90, described above.

In some embodiments of the presently disclosed subject matter, the movement platform can be utilized, except for rollators for the elderly or disabled people, to serve as a base for many applications and uses, such as personal vehicle, stroller for toddlers and the like.

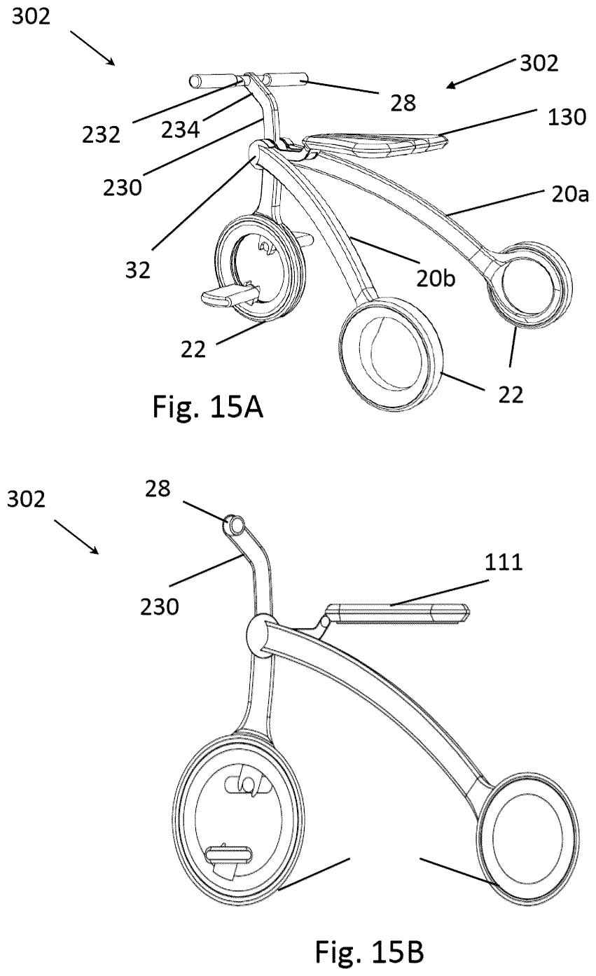

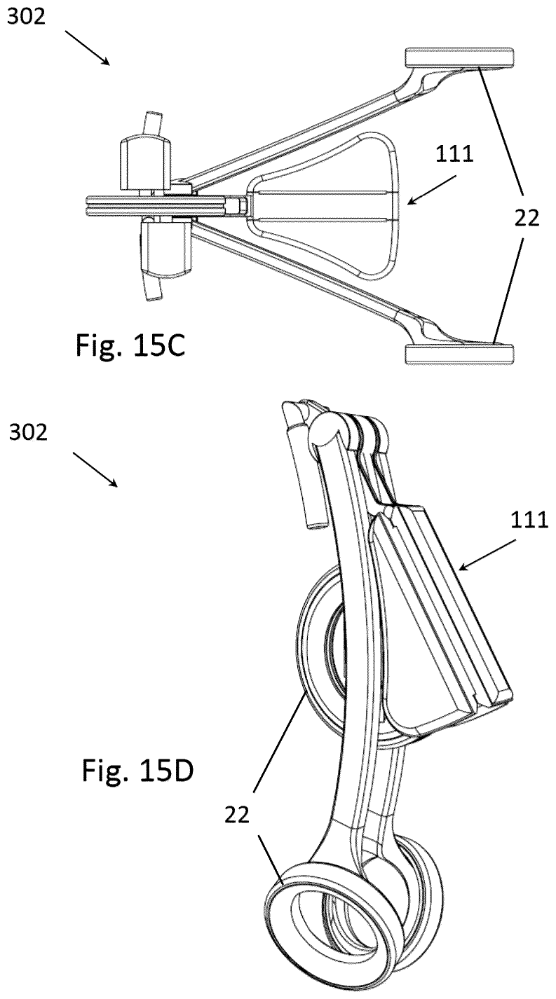

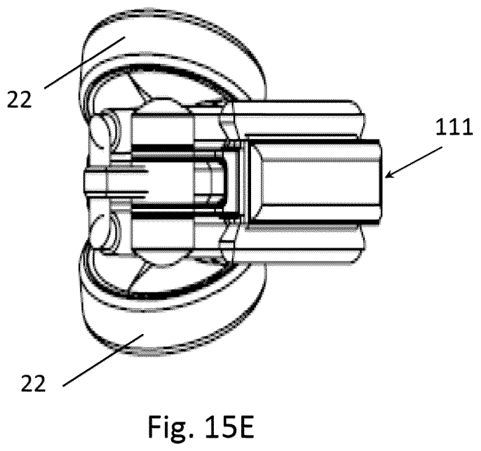

FIGS. 15A-15E show another platform, exemplified by a tricycle 302. Tricycle 302 has wheels 22; a seat 111; and handles 28—as well as a stem 230 and rear legs 20a and 20b, which are attached to hub 32, the rear legs being attached to the hub at their proximal ends 34a, 34b. Rear legs 20a and 20b can be folded manually, or via folding of handles 28, typically downward (FIG. 15D) at pivot points 232 thereof connecting to the top 234 of stem 230.

In some cases, (not shown) folding of the handles activates the folding of the rear legs via a deployment mechanism in the hub that can act in a manner as described above, mutatis mutandis.

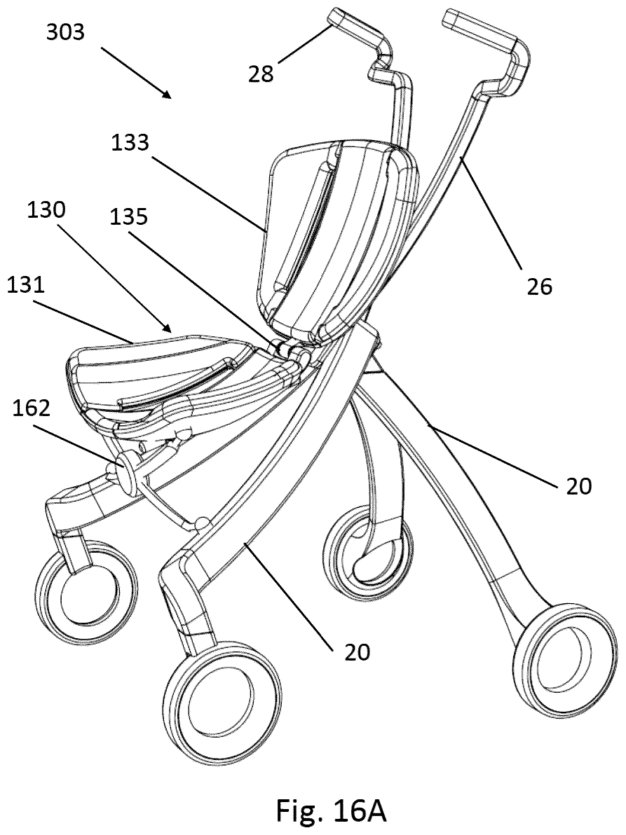

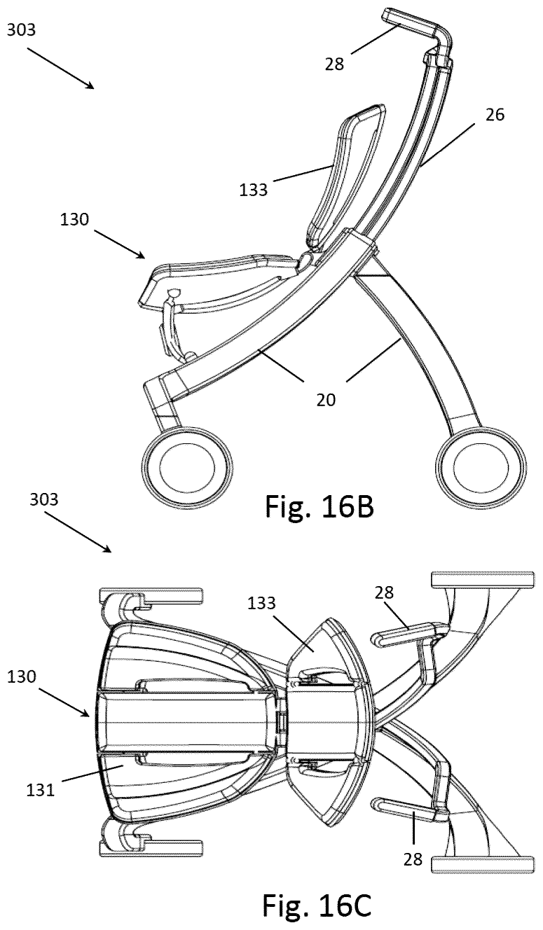

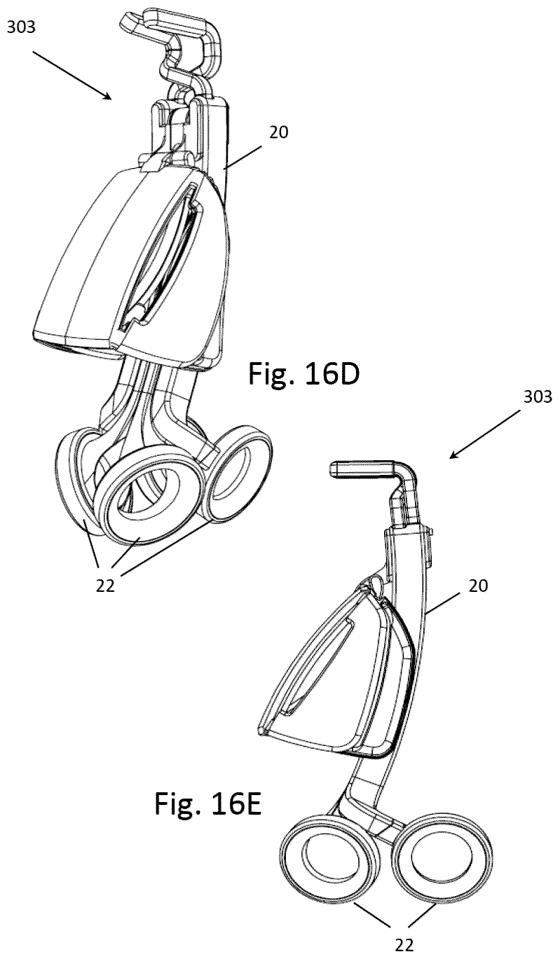

FIGS. 16A-16E show another platform, exemplified by a stroller 303. Stroller 303 comprises legs 20, typically four; arms 26 with handles 28; seat 130, having a sitting portion 131 and backrest 133. Arms 26 and legs 20 (in this case the legs facing frontward when deployed) interact as described above, in an x-shaped pattern, and with hub 32 (see for example FIGS. 1A and 5A-5I), also as described above. As such, raising arms 26 and separating handles causes legs 20 (the legs facing backward when deployed) to unfold, again, analogously as to the description above. Seat 130, in particular sitting portion 131 thereof, can fold in a manner similarly to as described with reference to FIGS. 9A-9F and FIGS. 10A-10B. Backrest 133 can be also folded, for example manually, about a seat pivot 135.

FIG. 17 shows an exemplary design of wheels 22, which can be used in the platform, according to the presently disclosed subject matter. Each of the wheels 22 has an annular configuration and includes an outer annular wheel member 152 that interfaces with the ground; an inner annular wheel member 157 configured to fit within the outer annular wheel member; a plurality of cylindrical roller bearings 154 configured to be housed in corresponding bearing housings 156 between the two annular wheel members 157 and 152; and a closure plate 158. Such design allows wheels 22 to be hubless, and consequently well suits wheel brake pad assembly 116.

When the at least one front leg is constituted by two front legs, a leg spreading mechanism can be introduced to assist separating the legs from each other thereby forming a stable structure. In such cases, the front legs are moveable between a retracted position, in which they are spaced from the reference plane to a first distance, and a deployed position in which they are spaced from the reference plane to a second distance larger than the first distance.

In some embodiments of the presently disclosed subject matter, the bottom openings of the hub can be configured with side surfaces that respectively restrict and allow movement of a leg relative to the reference plane. The side surfaces can have a first portion thereof in a first distance to the reference plane so as to abut at least a portion of the proximal end of the corresponding leg so as to prevent the corresponding front leg from moving away from the reference plane. The side surfaces can also have a second portion thereof in a second distance to the reference plane, being greater than the first distance, so as to allow the corresponding front leg to move away from the reference plane. Between the first portion and the second portion, the opening can be configured to have a gradual change in distance from the reference plane that can be stepped or continuous.

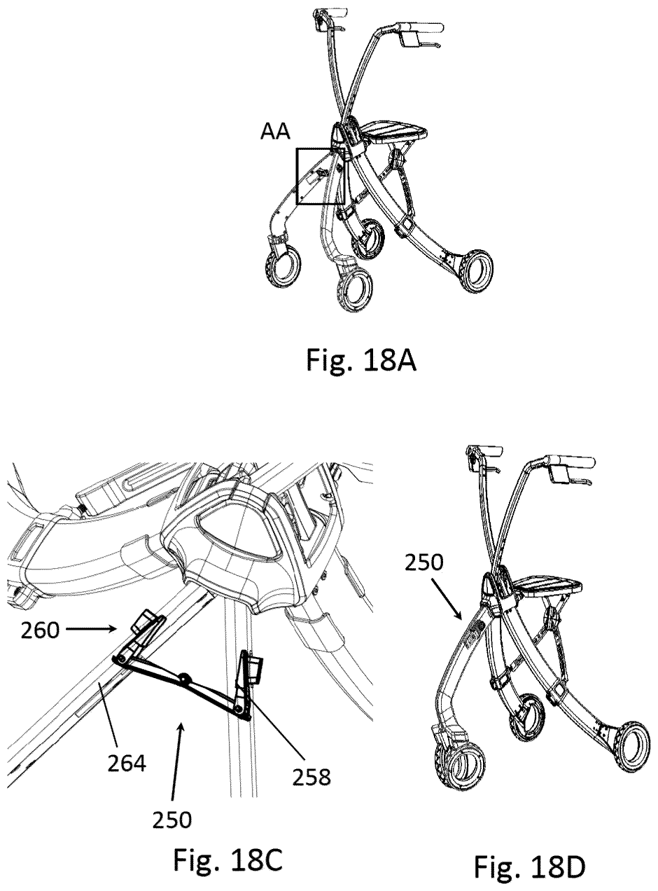

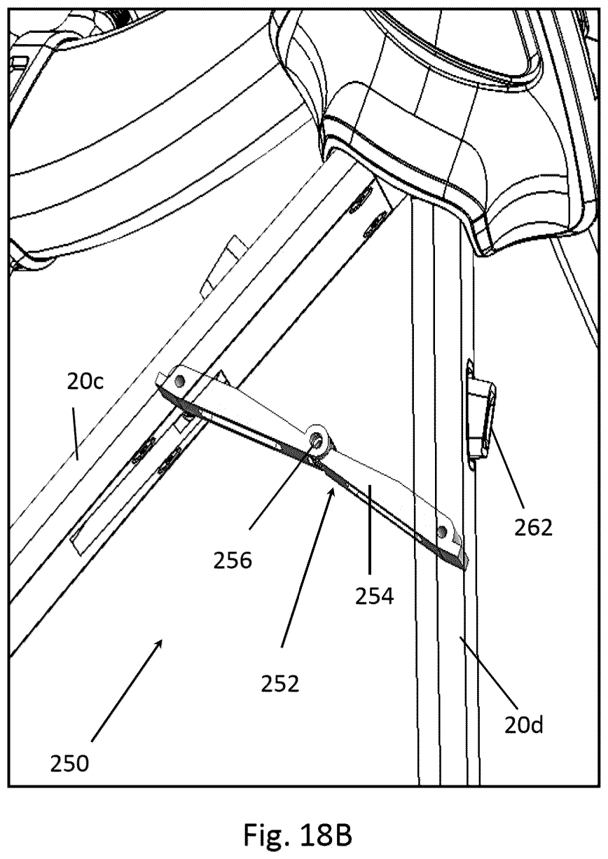

FIGS. 18A-18D show an example of a leg spreading mechanism 250 usable with the platform/rollator 301, shown in FIGS. 11A-11C, with the hub front portion 39 thereof comprising a funnel-shaped opening 400, as seen in FIG. 5B, via which the proximal ends 34 of the front legs 20c, 20d are received in the hub 32. The funnel-shaped opening 400 is inclined increasingly in a direction away from the hub 32, and comprises a proximal narrow portion (D) and a distal wide portion (E).

In some cases, the leg spreading mechanism can be disposed within the hub and can be configured to constantly apply an urging force in a direction away from the reference plane on the proximal ends of the front legs. Thus, when the front legs are in their proximal position, they abut the lower narrow portion (D) of the funnel shaped opening and are thus prevented from being urged laterally away from the reference plane. When the front legs 20c, 20d move from their proximal position towards their distal position, they no longer face the narrow portion (D) and are able to move further and further away until they face the upper wide portion (E) in which the are the farthest from the reference plane.

The leg spreading mechanism 250 is configured to bring distal ends 24 of front legs 20c and 20d from an adjacently parallel position to a spreading opened position, and vice versa, while optionally changing the orientation of the wheels relative to the ground. The leg spreading mechanism 250 of this example comprises a bridge 252 disposed between front legs 20c, 20d. Bridge 252 comprises two bridge strips 254 attached at their proximal ends by a bridge strip pivot 256, and their other ends being respectively connected (e.g., riveted) to a pair of actuator levers 258 (FIG. 18C) of the leg spreading mechanism 250. The bridge strip pivot 256 comprises an urging member (for example, a torsion spring) configure to apply a constant urging force onto the two bridge strips 254 so as to spread them from each other. Actuator levers 258 are actuatable by respective actuation buttons 262 at their free ends. Actuator levers 258 may be disposed internally within legs 20c, 20d, as illustrated in FIG. 11C, and are connected to distal ends of bridge strips 254.

In operation, when the front legs are moving towards their distal, opened position, the proximal portion of front legs 20c and 20d moves with respect to the hub from the proximal narrow portion (D), in which the urging force of the urging member translated to the proximal portion of the legs being forced against the hub, towards the distal wide portion (E), in which the widening of the funnel enables the legs to spread apart from each other until the bridge 252 is fully opened.

In order to fold the legs, pressing on leg-adjacency mechanism actuation buttons 262 causes the non-free ends of levers 258 to rotate, thereby downwardly rotating strips 254 so that their proximal ends move downward bringing front legs 20c, 20d toward each other (FIG. 18D), working against the force applicated thereon by the urging member. Strips 254 can be received in recesses 264 to allow a more complete adjacency of the legs 20C, 20d.

The platform, according to the presently discussed subject matter, may further comprise an orientation maintaining structure which is configured to maintain at least one wheel of the at least one front leg parallel to the reference plane in both the distal and proximal positions thereof. In cases where there are two front legs moveable between their retracted and deployed positions, each leg can be provided with such structure for maintaining the wheels of the front legs normal to the surface which the platform is to be used on, in all positions of the front legs. In some embodiments of the presently disclosed subject matter, the wheels of the front legs can be oriented differently with respect to the surface in the proximal and deployed position thereof.

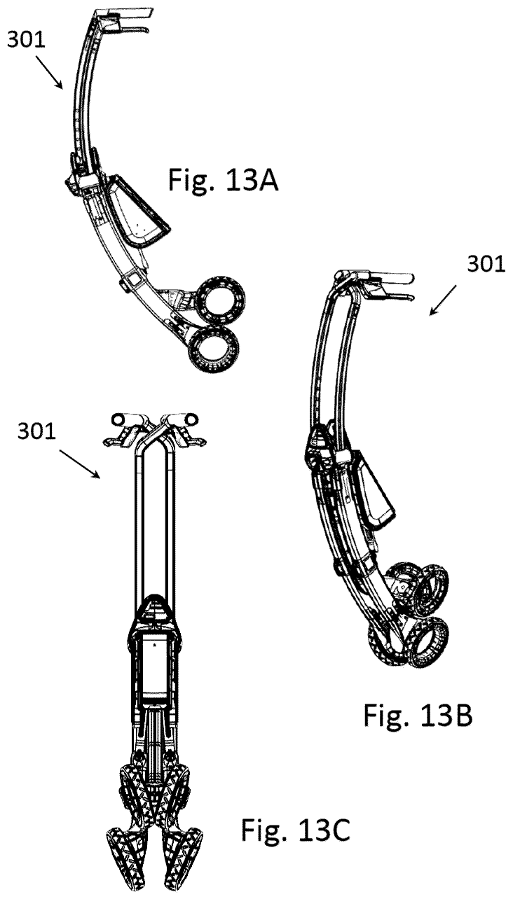

In some examples, the orientation maintaining structure can comprise a wheel articulating link which is articulated at a first and a second portion thereof to first and second portions of the corresponding front leg, thereby forming a parallelogram structure. Such structure enables the link, and thereby the wheel, upon pivoting of the at least one front leg from its proximal to its distal position, to maintain its orientation relative to the surface on which the platform is located. The first and second portions of the link can be distanced from each other where the first portion can be spaced from the wheel to a greater distance than the second portion. This orientation maintaining structure is especially beneficial in an embodiment of the presently disclosed subject matter in which there are two front legs, because it enables the front legs to move between a narrower gap upon deployment than the front legs illustrated in the embodiment in FIG. 13A-13C are able to move between, thereby negating the need for a delay mechanism.

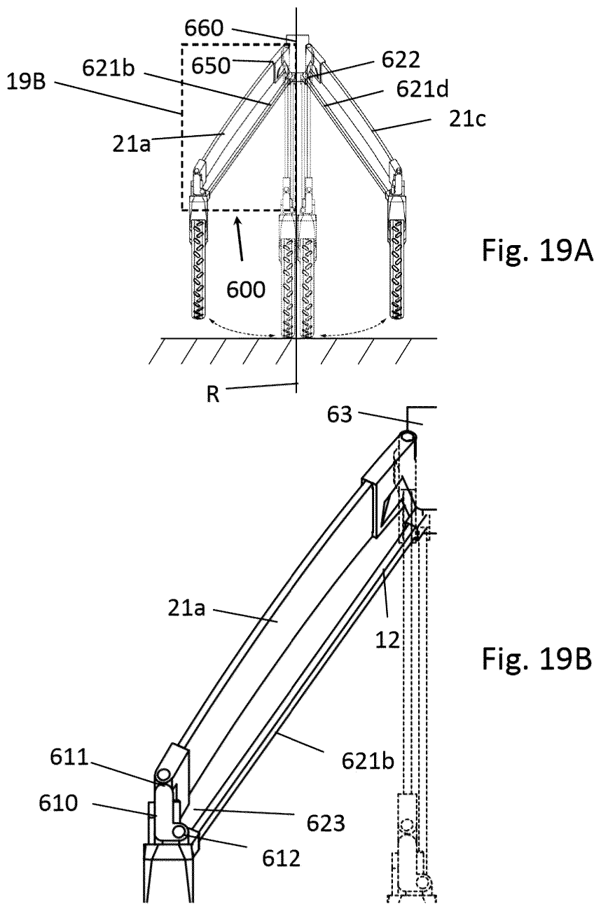

FIGS. 19A to 19B illustrate an example of the orientation maintaining structure 600 usable with a platform/rollator according to the presently disclosed subject matter, such as the platform shown in FIGS. 11A-13C. Each of the first legs of the moveable platform is provided with an orientation maintaining structure 600 comprising an elongated wheel connector 610 which is constantly maintained parallel to the reference plane (R) when the platform is positioned on a surface at least with its front legs, such that the wheels connected thereto are also configured to constantly be maintained parallel to the reference plane (R). The wheels can be connected to the orientation maintaining structure either directly or indirectly.

The orientation maintaining structure further comprises a balancing rod 621b, 621d extending parallel to its corresponding front leg 621a, 621c. Each balancing rod 621b, 621d having a proximal rod end 622 pivotally connected to the hub 32 via a connecting piece 660, and a distal rod end 623. The elongated wheel connector 610 comprises a first connector end 611 pivotally connected to the distal end of the corresponding first leg, and a second connector end 612 pivotally connected to the distal rod end 623. The first connector end 611 is located above the second connector end 612.

The proximal ends of the front leg and the corresponding balancing rod is operably connected, in pivoting manner, by a parallelogram forming portion (not shown). The parallelogram forming portion comprises a first end, to which the proximal end of the corresponding first leg is pivotally connected, and a second end to which the proximal rod end is pivotally connected. The ratios and distances between the first and second ends of the parallelogram forming portion are identical to those of the first and second connector ends 611 and 612 so as to form a parallelogram structure.

In some cases, when the front legs are in their proximal position, the balancing rod can be positioned, at least partially within the casing of the front legs, and in further cases, at least partially within the front legs themselves.

In the present example, each of the front legs 21a, 21c comprises a groove 650 in the proximal end thereof, that is configured for receiving therein, at least partially, the proximal rod end 622, which is constituted in this case by a box that fits within the groove when the front leg is moved to a proximal position. An urging element (not shown) is positioned between each front leg and its corresponding balancing rod, or between the balancing rod and the hub so as to urge the front leg and/or the balancing rod away from the reference plane R. When the legs move between proximal and distal position, the parallelogram structure maintains the wheel 22 in an orientation that is parallel to said reference plane R.

In some cases, the parallelogram forming portions of both front legs are constituted by a common, single parallelogram forming link associated with the front leg deployment mechanism, e.g., by being connected at least indirectly to the front leg transmission element.

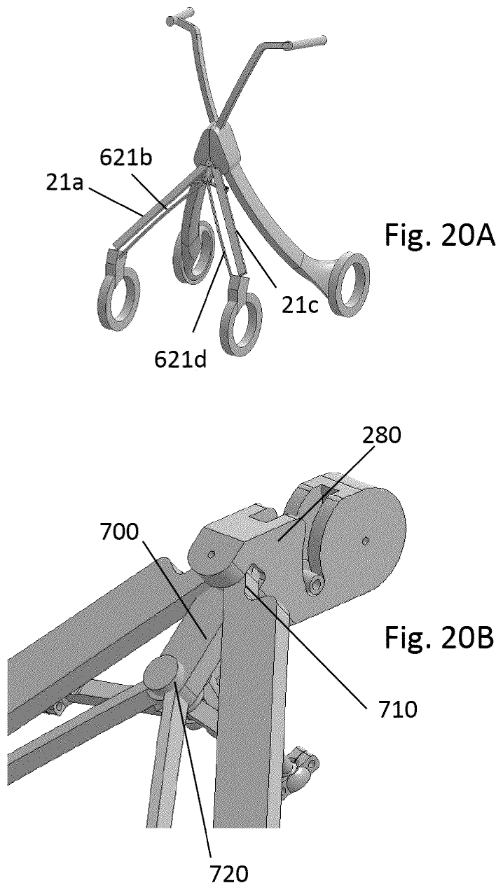

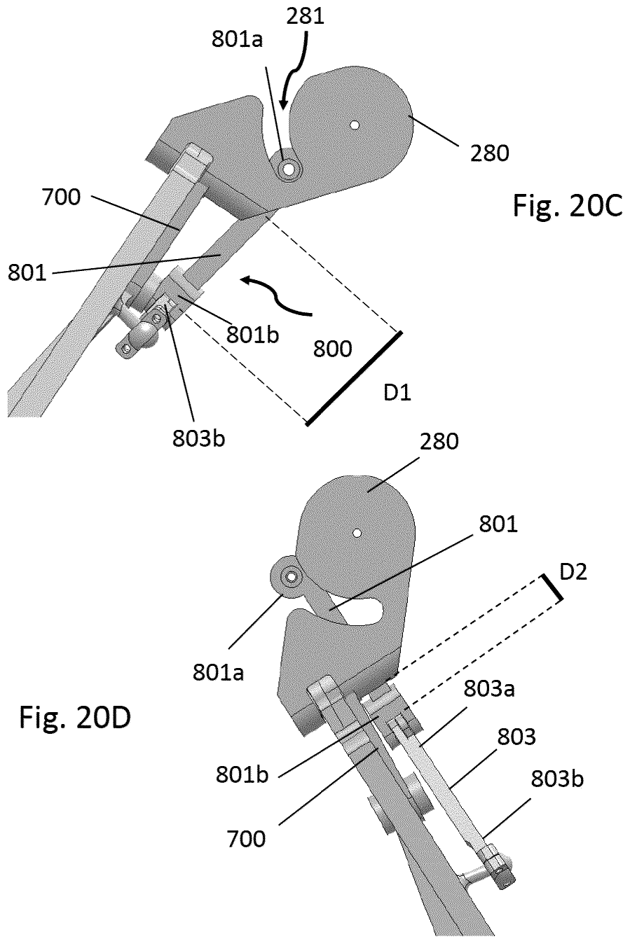

FIGS. 20A to 20D illustrate the above arrangement in which a parallelogram forming link 700 is connected to the leg transmission element 280 and having a top portion 710 pivotally connected to the leg transmission element 280 together with the proximal portion of the front legs 21a, 21c, and a bottom portion 720 to which the proximal rod ends 622 are pivotally connected. The distance between the top portion 710 and bottom portion 720 is about same to the distance between the first connector end 611 and the second connector end 612 of the elongated wheel connector 610.

In some embodiments of the presently disclosed subject matter, the movement platform can include an alternative leg spreading mechanism that can comprise an upper portion that is pivotably associated with the hub, and a lower portion that is associated, optionally via connecting rods, with the proximal ends of the front legs. The leg spreading mechanism can optionally be directly associated with the front leg deployment mechanism to provide further support to the front legs. The alternative leg spreading mechanism can be used with the front legs disclosed in FIGS. 19A and 19B. In other cases (not shown) the alternative leg spreading mechanism can be used with the front legs disclosed in FIG. 11A-12B.

FIGS. 20A to 20D also illustrate an alternative leg spreading mechanism 800. The alternative leg spreading mechanism 800 can be associated with the front leg transmission element 280 of a front leg deployment mechanism, which can be incorporated with the front leg deployment mechanism disclosed above.

In the present example, the alternative leg spreading mechanism 800 includes a main lever rod 801 and two front leg connecting rods 803. The main lever rod 801 having a upper end 801a, at which the main lever rod 801 is pivotally connected, at least indirectly, to the hub, and a bottom end 801b. Each of the two front leg connecting rods 803 has a proximal end 803a, at which the front leg connecting rod 803 is articulately connected to the lower end 801b of the main lever rod 801 and a distal end 803b, at which each front leg connecting rod 803 is articulably connected to the proximal ends of the front legs 20c, 20d.

In the present example, the upper end 801a of the main lever rod 801 is configured to be received within a slot 281 in the leg transmission element 280 so as to limit the extent to which the leg transmission element 280 can be pivoted towards the opened, deployed position of the front legs 21a,21c. Additionally, by having the upper end 801a of the main lever rod 801 being configured to be inserted into the slot, the distance between the lower end 801b to the leg transmission element 280 changes. When the front legs are in their closed, proximal position, as shown in FIG. 20D, the distance D2 between the lower end 801b and the leg transmission element 280 is shorter than the distance D1 between the lower end 801b and the leg transmission element 280 when the front legs are in their distal, deployed position. When the distance between the lower end 801b and the leg transmission element 280 is increased from D1, the main lever rod 801 urges the proximal ends 803a of the connecting rods 803 in the direction of increasing distance. Because the distal ends 803b of the connecting rods 803 are pivotally connected, at least indirectly, to the proximal end of the leg, the rigid body movement of the connecting rods 803 urge the front legs away from each other.

In operation, when the front legs are moved towards their distal position via the leg transmission element 280, the upper end 801a of the main lever rod 801 moves relative to the slot 281 in the leg transmission element 280. The lower end 801b moves farther from the leg transmission element 280 and the resulting rigid body movement of the front leg connecting rods 803 urge the front legs 20c, 20d, to separate relative to each other.

In another example of the presently disclosed subject matter a platform or device for supporting a user on a surface, at least during movement in a frontward direction, can comprise at least two arms, a number of legs having wheels and at least one brake mechanism. The at least one brake mechanism can be associated with one of the arms, and can comprise a brake actuating lever, and a brake assembly operably connecting the brake actuating lever to at least one of the wheels to allow selectively preventing the at least one wheel from rotating. In some examples, the at least one brake mechanism can be constituted by two brake mechanisms, each associated with one of the at least two arms.

The brake mechanism in the presently described example can include features corresponding to those described previously herein with respect to the brake mechanism for use in an extendable arm-leg assembly where the arm and the leg are operably and movably engaged in a telescopic manner, at least along an overlapping area of the arm-leg assembly. In such configurations, at least one of the arm and leg includes a hollow portion associated with the overlapping area. In these cases, the presently described braking assembly can include the previously described actuatable element, constituted by a brake-pad assembly and the previously described interconnecting structure, constituted by a brake cable unit. Further, the platform or device can include any or all of the features described in relation to the rollators or platforms previously discussed herein. The platform or device can be constituted by a rollator.

In a platform or device according to the presently described example, at least one of the arms can have a handle connected to the arm at a handle proximal end. The handle can have a free handle distal end spaced rearwardly from the arm, and such a length so as to allow the user to at least partially grasp the handle at a location spaced from the handle proximal end. The brake actuating lever can have a distal lever end connected to the handle adjacent the free handle distal end, and a free proximal lever end frontwardly spaced from the handle distal end. In the presently disclosed example, ‘adjacent’ is defined as ‘near or at.’ Specifically, the distal lever end is connected to the handle either at the handle distal end or in close proximity to the handle distal end. In configurations comprising two brake mechanisms, each arm can include a handle with the brake-actuating lever of each mechanism connected to the respective handle. Each lever is operably linked via the respective brake assembly to one or more corresponding wheels, allowing selective braking functionality.

The proximal lever end of the lever can be moved by a user to operate the braking mechanism by applying force to the lever while grasping the handle. The user can apply force to the proximal lever end either indirectly, by exerting force along the body of the lever near the proximal end, or directly to the proximal lever end itself. Thus, when operating the brake mechanism, the user applies force to the lever at a location spaced from the handle's free distal end, prompting the user to grasp the handle at a position forward of the handle's distal end. By positioning their hand on the handle sufficiently forward of the handle's distal end during use of the device, the user minimizes or eliminates the need to adjust their grip when transitioning from a grip used during forward motion with the device to a grip required for operating the brake mechanism. This forward hand positioning, promotes a more ergonomic posture for a user. The forward hand positioning improves weight distribution onto the device, enhancing the device's stability during both forward motion and braking. The improved stability and ergonomic positioning may provide increased comfort for the user as well as a safer user experience.

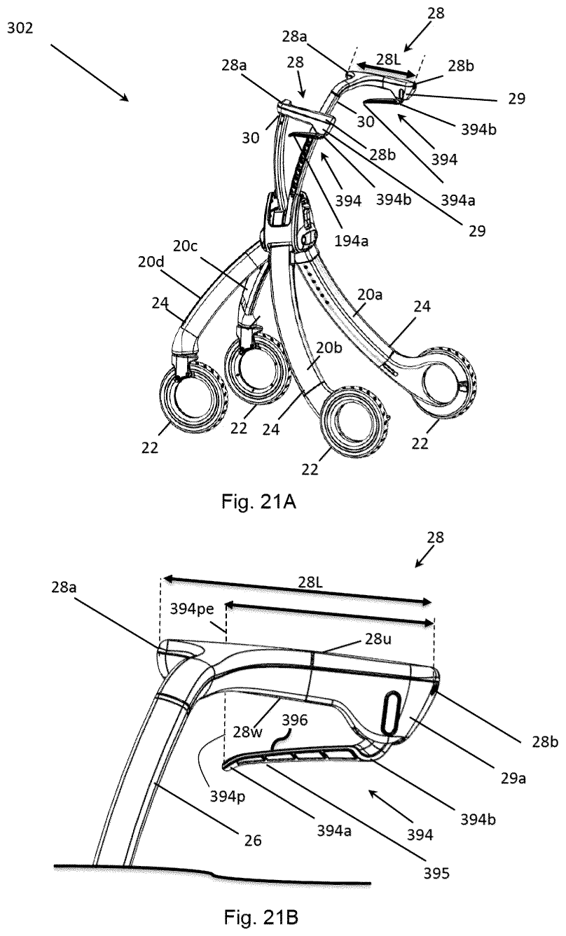

FIG. 21A illustrates a perspective view of a device constituted by a rollator 302, according to the presently disclosed subject matter. Where the description above refers only to rollator 300 or 301, it should be seen as applicable also to rollator 302, unless indicated otherwise. Rollator 302 includes four legs, these legs being front and rear legs, namely a right rear leg 20a, a left rear leg 20b, a right front leg 20c, and a left front leg 20d with wheels 22 at their distal ends 24; and also includes two arms, namely a left arm 26a and a right arm 26b, with handles 28 at their distal arm portions 30. The handles 28 are connected to the respective arms 26a, 26b at respective proximal handle ends 28a. The handles 28 each extend to a free distal end 28b, which is spaced rearwardly from the arm 26a, 26b, with a length 28L designed to allow the user to at least partially grasp the handles 28 at a location spaced from its proximal end 28a.

The rollator 302 comprises a brake mechanism constituted by the movement transmission mechanism described with reference to FIGS. 14A-14D, however with a different brake actuating lever designated 394. The brake mechanism comprises a brake assembly (not seen) comprising the brake cable and brake-pad assembly of the kinds described with reference to FIGS. 14A-14D. The brake actuating lever 394 comprises a distal lever end 394b attached to the handle 28 near its free distal end 28b and a free proximal lever end 394a positioned frontwardly from the handle's distal end 30b. The proximal lever end 349a can be moved by the user to operate the braking mechanism by applying force—either directly or indirectly—thereto while grasping the handle.

In the presently described example, the handle can comprise a lower surface facing the surface on which the user is supported, and an opposing upward-facing surface shaped to support a portion of the user's hand when grasping the handle. In some examples, the brake-actuating lever can be operatively connected to the upper surface of the handle, or to an outer side surface located between the upper and lower surfaces. In other examples, the brake-actuating lever can be operatively connected to the lower surface of the handle, or in some cases to more than one aforementioned surface of the handle.

One or more surfaces of the handle can comprise a lever holding interface adjacent the free handle distal end, which facilitates the attachment of the lever. In some examples, the lever can comprise a lever distal end that is pivotably connected to the lever holding interface. In such examples, the lever holding interface may be constituted by a protrusion accommodating a hinge by which the lever is pivotably connected to the handle. Notably, the lever-holding interface can obstruct a user from grasping the handle at its location, urging a user to grasp the handle at a position forwardly spaced from the handle free distal end.

At least in examples wherein the lower surface of the handle comprises the lever holding interface, the brake-actuating lever can comprise a lower lever surface oriented toward the surface on which the user is supported and an opposing upward-facing lever surface oriented toward the handle. The lower lever surface can be spaced from the upward-facing surface of the handle to allow the user to engage it with their fingertips while maintaining contact with the handle with a portion of their palm. The user can apply a squeezing force with their fingertips on the lower lever surface, pulling it toward their palm, which is in contact with the handle's upper surface, to move the lever toward the handle and actuate the braking mechanism.

FIG. 21B illustrates a cut-away side view of a handle 28 and brake actuating lever 394 connected to arm 26 of a rollator/device according to the presently disclosed subject matter, having the same features as those shown in FIG. 21A. The handle 28 comprises an upward-facing surface 28u shaped to support a portion of the user's hand when grasping the handle, and an opposing lower surface 28w comprising a lever holding interface 29 adjacent the free handle distal end 28b. The lever holding interface 29 comprises a protrusion 29a accommodating a hinge (not seen) to which the lever distal end 194b is pivotably connected.

The brake-actuating lever 394 comprises a lower lever surface 395 oriented toward the surface on which the user is supported and an opposing upward-facing lever surface 396 oriented toward the handle 28. The lower lever surface 395 is spaced from the upward-facing surface 396 to allow the user to engage it with their fingertips while maintaining contact with the handle with a portion of their palm.

In a rollator or device according to the presently discussed example which comprises two handles and associated braking mechanisms, the lever holding interface of the handles can be spaced forwardly from the rear wheels. In the example illustrated in FIG. 21A, the lever holding interfaces 29 of each of the handles 28 is spaced forwardly from the rear wheels 22.

In the presently described example, a projection of the proximal end of the lever onto the handle can be spaced from the handle distal end to a distance of at least one third, or optionally at least half of the length of the handle between the distal and proximal ends thereof. In some cases, the projection of the proximal end of the lever onto the handle can be spaced from the handle distal end to a distance of three quarters or the full length of the handle. The lever can be constituted by an elongated element, and can extend parallel to at least a portion of the handle at least along a majority of the handle length. In some cases, the free proximal end of the brake actuating lever can comprise a curved extension. This curvature can help keep a user's fingers in contact with the lever by preventing them from slipping off of the free end of the lever.

In the example illustrated in FIG. 21B, a projection of the proximal end 394a of the lever 394 onto the handle 28 is spaced from the handle distal end to a distance larger than half of the length of the handle between the distal and proximal ends thereof. The projection is illustrated by projection line 394p extending from the proximal end 394a of the lever 394 onto the handle 28. An extension 394pe of the line 394a is provided above the handle to illustrate the length of the projection relative to the length 28L of the handle 28. The lever 28 is constituted by an elongated element, and extends parallel to at a portion of the handle along the majority of the handle length 28L. The proximal end 394a of the brake actuating lever comprise a curved extension.

The brake actuating lever 394 described with respect to FIGS. 21A and 21B can constitute the brake actuating lever of any of the examples of a rollator or device comprising the brake mechanism described herein. For example, the brake mechanisms described with reference to FIGS. 8A-8D and FIGS. 14A-14D can comprise brake actuating lever 394 instead of lever 94.

It should be understood that the above description is merely exemplary and various embodiments of the present presently disclosed subject matter may be devised, mutatis mutandis, and that the features described in the above-described embodiments, and those not described herein, may be used separately or in any suitable combination; and the presently disclosed subject matter can be devised in accordance with embodiments not necessarily described above.

1. A device for use to support a user on a surface, the device comprising, at least in operation:
at least one front leg, a right rear leg and a left rear leg, each leg having a proximal end and a distal end, wherein the distal end of each leg may directly contact said surface;
a right arm having a distal end and a proximal end, the right arm engaging the left rear leg, thereby constituting a first arm-leg assembly;
a left arm having a distal end and a proximal end, the left arm engaging the right rear leg, thereby constituting a second arm-leg assembly; and
a hub to which the first and second arm-leg assemblies are pivotably connected so as to enable the front and rear legs with the corresponding arms to pivot between distal positions thereof and proximal positions thereof, the distal ends of the legs being closer to each other in the proximal position than in the distal position of the legs, and the proximal position of the legs being achieved by moving the right and left arms from an arms distal position in which the arms are spread apart, to an arms proximal position in which the distal ends of the arms are closer to each other than in the arms distal position, whereby the device can be brought from a deployed state in which the arms and the rear legs are in their distal positions, into a folded state in which the arms and the rear legs are in their proximal position,
wherein the arm-leg assemblies are pivotable so as to form an X-shaped structure when the device is in the deployed state, and to extend parallel to each other at least along a majority of the length thereof when the device is in the folded state, and
wherein in each of the two arm-leg assemblies, the legs have a curved shape, at least along a proximal portion thereof comprising their proximal ends, and the arms have a curved shape identical to that of the legs, at least along a majority of the length of the arms, so as to allow the arms to slidingly move so as to become aligned with, or be received in, the rear legs at least along the majority of the length of the arms at least when bringing the device into the folded state.

2. The device of claim 1, wherein the right arm is slidingly moveable with respect to the left rear leg and the left arm is slidingly moveable with respect to the right leg, each arm slidable between an extended state in the deployed state of the device; and in which the distal ends of the arms are spaced from the hub, and a retracted state which the arms have in the folded state of the device and in which the distal ends of the arm are disposed adjacent to the hub.

3. The device of claim 2, wherein in the retracted state of the arms, the proximal ends thereof are disposed farther from the hub than the distal ends of the arms and closer to the distal ends of the rear legs than the hub.

4. The device of claim 1, wherein the hub has front and rear hub portions and accommodates therewithin proximal ends of at least the two rear legs, which are connected to the hub so as to be pivotable about corresponding longitudinal pivot axes thereof passing through the front and rear portions of the hub at two horizontally spaced apart locations.

5. The device of claim 1, further comprising a front leg deployment and folding mechanism, accommodated within the hub, and operable to move the at least one front leg between a front leg distal position in which the distal end thereof is disposed at a maximal distance from the distal ends of the rear legs when the rear legs are in their distal position, and a front leg proximal position, in which the distal end of the at least one front leg is disposed proximal to the distal ends of the rear legs, when the rear legs are in their proximal position.

6. The device of claim 5, wherein in the proximal position of the front and rear legs, the at least one front leg is at least partially located between the rear legs.

7. The device of claim 5, wherein the front leg deployment and folding mechanism is operable to move the at least one front leg between the front leg distal and proximal positions, when the rear legs are brought between their respective distal and proximal positions.

8. The device of claim 1, wherein each of the two arm-leg assemblies has a center-line longitudinal axis, which is continuously convexly curved, and oriented so that its frontmost area is disposed at a distal portion of the arm.

9. The device of claim 1, wherein the center of the X-shaped structure that is formed when the device is in the deployed state thereof, is positioned above the pivoting point of each of the assemblies in a side view.

10. The device of claim 1, wherein each arm has a handle extending rearward from the proximal end of the arm and, in each of the arm-leg assemblies, the center-line longitudinal axis is so oriented that, in the side view of the device, the distal end of the leg is located to the rear of the projection of the handle on said surface.

11. The device of claim 1, wherein the device is a rollable device, for supporting a user on a surface; and wherein the or each one front leg has a proximal end disposed within the hub and a distal end, the front and rear legs having wheels operably connected thereto and spaced from the hub towards said surface when the device is positioned thereon.

12. The device of claim 11, further comprising at least one brake mechanism associated with at least one of said arms, said brake mechanism comprising a brake actuating lever and a brake assembly operably connecting said brake actuating lever to at least one of said wheels to allow selectively preventing the at least one wheel from rotating, said brake actuating lever having a distal lever end connected to the handle adjacent the free handle distal end, the lever having a free proximal lever end frontwardly spaced from the handle distal end, the proximal lever end being movable by a user, to operate said brake mechanism, by applying to the proximal lever end, a force, at least indirectly, while grasping said handle.

13. The device according to claim 12, wherein a projection of the proximal end of the lever onto the handle is spaced from the handle distal end to a distance of at least one third, optionally at least half of the length of the handle between the distal and proximal ends thereof.

14. The device of claim 1, further comprising at least one arms securing element attached to the hub so as to be movable an open state, in which the first and second arm-leg assemblies are allowed to pivot between the distal positions and the proximal positions thereof, and a closed state, in which the first and second arm-leg assemblies are prevented from pivoting between the distal positions and the proximal positions thereof.

15. The device of claim 14, further comprising a securing element handle protruding from at least said arm securing element in a direction away from the hub in the closed position of the arm securing element.

16. The device of claim 15, wherein the hub comprises front and rear hub portions spaced from each other by a top opening of the hub, the front and rear hub portions being connected the arms securing element at the top opening, when the at least one arms securing element is in its closed state, and the handle protruding from the arm securing element in the direction away from the top opening in the closed position of the arm securing element.

17. The device of claim 14, wherein the right arm is slidingly moveable with respect to the left rear leg and the left arm is slidingly moveable with respect to the right leg, each arm slidable between an extended state in the deployed state of the device; and in which the distal ends of the arms are spaced from the hub, and a retracted state which the arms have in the folded state of the device and in which the distal ends of the arm are disposed adjacent to the hub, and wherein said securing element, when in the open state, allows the arms to move between the extended state and the retracted state, and when the closed state, prevents the arm from moving from the retracted state into the extended state.

18. The device of claim 14, wherein in the closed state the at least one arms securing element applies pressure on the arms so at to prevent the first and second arm-leg assemblies from pivoting.

19. The device of claim 1, further comprising a seat attachable to the hub and to the rear legs.

20. The device of claim 19, wherein the seat is pivotably connectable to the hub so as to allow the seat to pivot upward and downward whereby the seat can be positioned in an operational raised orientation in which a user can sit thereon while facing in a rearward direction, and a non-operational downward orientation.

21. The device of claim 1, wherein the arm and the leg of each arm-leg assembly are operably and movably engaged with each other in a telescopic movement manner at least along an overlapping area of the arm-leg assembly, at least one of the arm and the leg having a hollow portion associated with the overlapping area;
the device further comprising a brake mechanism, the brake mechanism comprising:
an actuating element constituted by a brake actuating lever connected to the arm;
an actuatable element constituted by a brake-pad assembly connected to the leg; and
an interconnecting structure constituted by a brake cable unit comprising an outer flexible sleeve and an inner flexible brake cable passing through said sleeve and having an arm-associated portion including one cable end attached to the brake actuating lever and a leg-associated portion including a second cable end attached to the brake-pad assembly, the outer sleeve with the inner cable therewithin that interconnects the arm-associated portion and the leg-associated portion constitutes an interconnecting element forming a loop having such dimensions as to be capable of being received within said hollow portion, wherein the length of the interconnecting element is about equal to the length of at least the overlapping area, wherein the length of the interconnecting element is variable in accordance with that of the overlapping area.

22. The device of claim 1, wherein the at least one of the front leg is constituted by two front legs located on different sides from a reference plane defined by the hub and normal to the surface, each front leg being moveable between a retracted position, in which the front leg is spaced from the reference plane to a first distance and a deployed position, in which it is spaced from the reference plane to a second distance larger than the first distance; each of the front legs being provided with an orientation maintaining structure comprising an elongated wheel connector configured to be maintained parallel to the reference plane in both the distal and proximal positions of the corresponding front leg.
